(19) United States
(12) Patent Application Publication
(10) Pub. No.: US 2008/0252448 A1
(43) Pub. Date: Oct. 16, 2008

(54) SYSTEM AND METHOD FOR EVENT DETECTION UTILIZING SENSOR BASED SURVEILLANCE

(76) Inventors: Lalit Agarwalla, Bangalore (IN); Sergio Borger, Paramus, NJ (US); Lisa M. Brown, Pleasantville, NY (US); Christopher R. Carlson, Costa Mesa, CA (US); Raymond A. Cooke, Bloomington, MN (US); Barry Gottlieb, Short Hills, NJ (US); Arun Hampapur, Norwalk, CT (US); Christopher A. LoGiudice, Bethel, CT (US); Linda C. Owen, Counce, TN (US); Andrew W. Senior, New York, NY (US); Chiao-Fe Shu, Scarsdale, NY (US)

Correspondence Address: HOFFMAN WARNICK LLC, 75 STATE ST, 14TH FLOOR, ALBANY, NY, 12207, US

(21) Appl. No.: 11/972,765

(22) Filed: Jan. 11, 2008

Related U.S. Application Data
(60) Provisional application No. 60/884,867, filed on Jan. 12, 2007.

(51) Int. Cl. G08B 21/00

(52) U.S. Cl. 340/540

(57) ABSTRACT

The present invention includes a method, system, and program product for detecting an event that includes receiving at least one data input stream from one or more sensors, selecting a data input stream from one of the one or more sensors, recording the data input stream on a recordable medium, specifying a rule comprising an event in the data input stream, and detecting at least one event in the data input stream based upon the rule.

### CROSS-REFERENCE TO RELATED APPLICATION

The present application claims the benefit of provisional patent application No. 60/884,867, entitled SYSTEM AND METHOD FOR EVENT DETECTION UTILIZING SENSOR BASED SURVEILLANCE, filed Jan. 12, 2007, the entire contents of which are herein incorporated by reference.

### FIELD OF THE INVENTION

The present invention generally relates to event detection in surveillance systems. Specifically, aspects of the present invention address a need for event detection and alert generation based upon physical location and sensor based surveillance.

### BACKGROUND OF THE INVENTION

Theft and shoplifting significantly impact the profitability of retail establishments. Thus, detecting malefactors pursuing such activities is of paramount importance, as the competitive landscape in retail sales has grown significantly more challenging in recent years. Also, events in the last decade have demonstrated the need for improved surveillance and detection of suspicious activities to deter violent attacks. Current surveillance systems do not adequately address these requirements. In view of the foregoing, there exists a need for a solution that solves at least one of the deficiencies of the related art.

### SUMMARY OF THE INVENTION

In general, the present invention provides a smart security system in which a data input stream from one or more sensors (e.g., cameras) is received and recorded. Based on a specified rule, an event in the data input stream can be detected. The detection of the event is performed substantially contemporaneously with the receipt of the data input stream from the one of the one or more sensors, or based upon receipt of the data input stream from playback of the recordable medium. Based on the detection of the event, an alert can be generated. This alert can comprise identifying the particular sensor from which the data input stream was received (e.g., depicting its location on a map). The specification of the rule can comprise marking an annotation (e.g., a boundary line) on the data input stream.

A first aspect of the present invention provides a method for detecting an event, comprising receiving at least one data input stream from one or more sensors, selecting a data input stream from one of the one or more sensors, recording the data input stream on a recordable medium, specifying a rule comprising an event in the data input stream, and detecting at least one event in the data input stream based upon the rule.

A second aspect of the present invention provides a system for detecting an event, comprising means for receiving at least one data input stream from one or more sensors, means for selecting a data input stream from one of the one or more sensors, means for recording the data input stream on a recordable medium, means for specifying a rule comprising an event in the data input stream, and means for detecting at least one event in the data input stream based upon the rule.

A third aspect of the present invention provides a method for deploying a system for detecting an event, comprising providing a computer infrastructure being operable to receive at least one data input stream from one or more sensors, select a data input stream from one of the one or more sensors, record the data input stream on a recordable medium, specify a rule comprising an event in the data input stream, and detect at least one event in the data input stream based upon the rule.

A fourth aspect of the present invention provides a program product stored on a computer readable medium for detecting an event, the computer readable medium comprising program code for causing a computer system to: receive at least one data input stream from one or more sensors, select a data input stream from one of the one or more sensors, record the data input stream on a recordable medium, specify a rule comprising an event in the data input stream, and detect at least one event in the data input stream based upon the rule.

### BRIEF DESCRIPTION OF THE DRAWINGS

These and other features of this invention will be more readily understood from the following detailed description of the various aspects of the invention taken in conjunction with the accompanying drawings in which:

FIGS. 1-9 depict a graphical user interface according to the present invention.

FIGS. 10-24 depict loss prevention management aspects of the present invention.

FIGS. 25-56 depict store management aspects of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a smart security system in which a data input stream from one or more sensors (e.g., cameras) is received and recorded. Based on a specified rule, an event in the data input stream can be detected. The detection of the event is performed substantially contemporaneously with the receipt of the data input stream from the one of the one or more sensors, or based upon receipt of the data input stream from playback of the recordable medium. Based on the detection of the event, an alert can be generated. This alert can comprise identifying the particular sensor from which the data input stream was received (e.g., depicting its location on a map). The specification of the rule can comprise marking an annotation (e.g., a boundary line) on the data input stream.

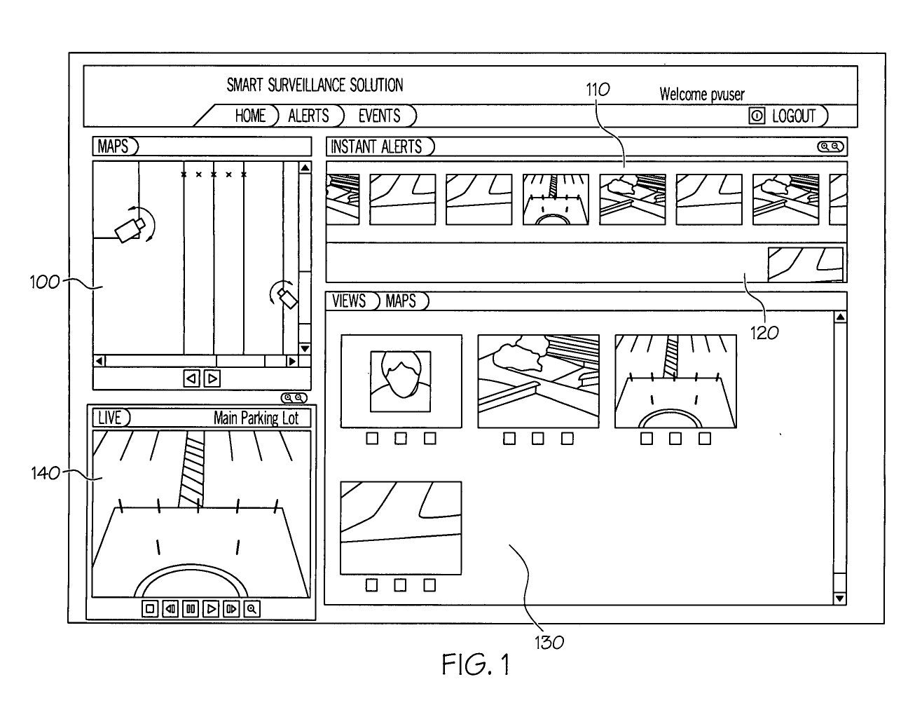

FIG. 1 shows the user interface with 4 basic zones. Element 100 shows the map of the facility with the location of sensors (e.g. cameras) on them. The color of the shaded zone on the camera shows the status of alerts on the cameras, for example, green is no alert, yellow is alert of type #1, orange is alert of type #2, red is alert of type #3 etc. Element 110 shows the real-time alert visualization zone. Each alert is reported in this zone within a short time (i.e. substantially contemporaneously) of the occurrence of the event. An alert is reported by automatically placing a key-image from the camera onto the zone and sounding an audible alarm (tone or voice announcement). As the zone fills up the alert notifications are scrolled from left to right with a scroll bar which allows the user to browse through the various alert notifications. The user can choose to view the view corresponding to any of the alerts by clicking on the alerts.

Element 120 shows an expanded summary of alerts that have occurred in the system. Each alert is represented by a different colored bar, thus allowing the user to visually assess the type of alerts that occur frequently and the pattern in which alerts occur, for example, yellow followed by green, followed by red may indicate that these they alerts typically fire in a sequence. Element 130 shows a thumbnail taken from each of the cameras connected to the Smart Surveillance System (a.k.a “S3”). Below each camera view (a.k.a. data input stream) are buttons which allow the user to select the camera, and launch the alert configuration tool. Also, data input streams may be recorded on a recordable medium.

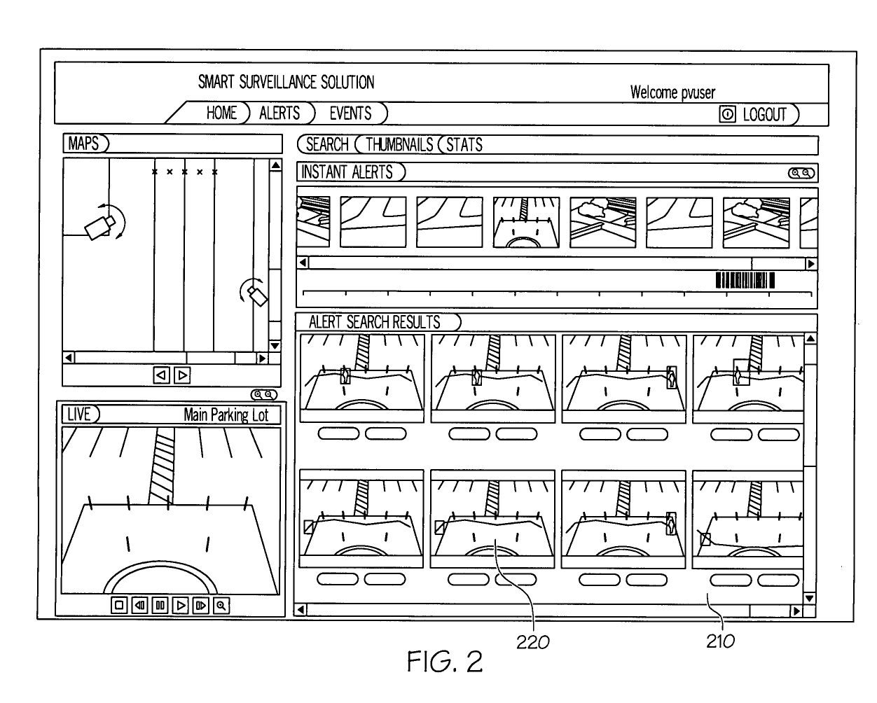

FIG. 2 shows the user interface where the user is browsing thru the last 100 alerts for a selected camera. Element 210 is the zone where the keyframes from each of the alerts is displayed. Element 220 is a single keyframe which represents the occurrence of a user defined alert. The key frame is selected from the camera and shows the object that is triggering the alert rule that has been set up by the user.

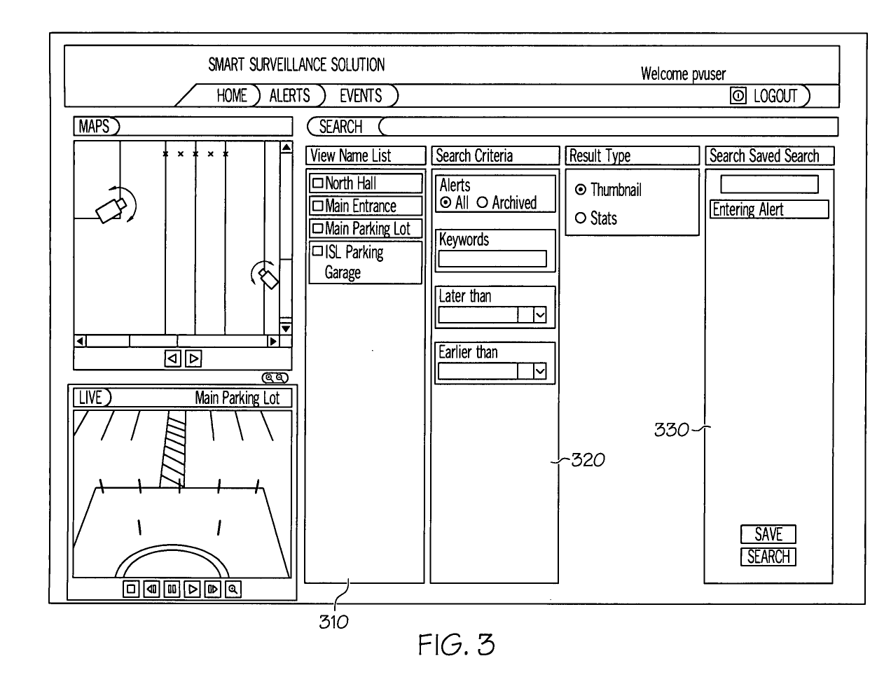

FIG. 3 shows the user interface for searching through the database of alerts. Element 310 shows the list of cameras in the system. The user can select one or more cameras to perform the alert search. Element 320 shows the various criteria for searching thru alerts including: 1) Keyword (this is the title of the alert), 2) Time Interval Start, and 3) Time Interval End. Element 330 shows the list of previously saved alert searches and provides the user with a mechanism to save a particular search.

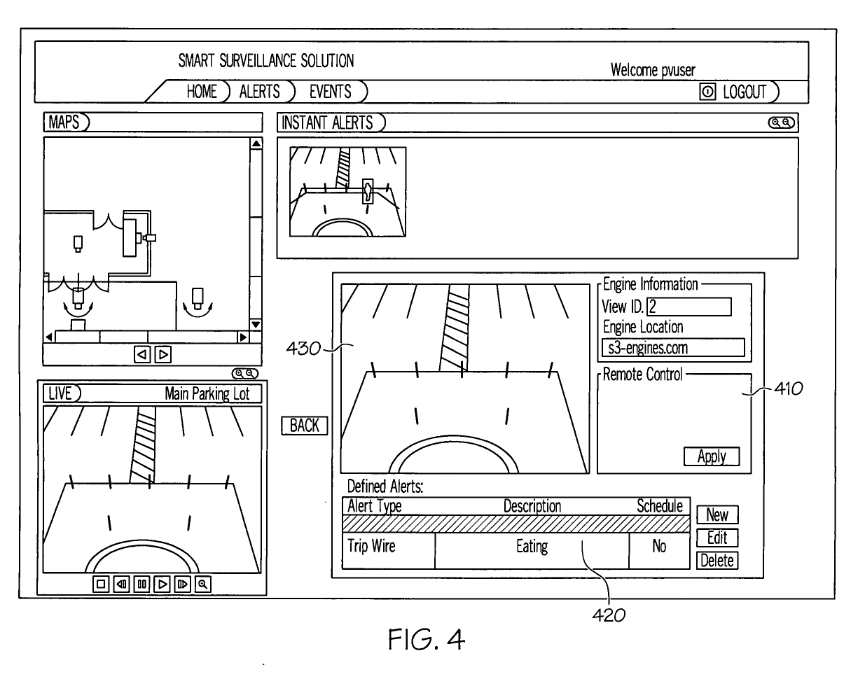

FIG. 4 shows the user interface where the user can setup a variety of alert definitions. Element 410 is a window where the user can setup the alert. Element 420 shows the list of alerts which are currently setup on the camera; the user can edit, or delete existing alerts. Element 430 shows the process of defining an alert using a mouse (drawing zones of interest, no interest, defining rules, etc).

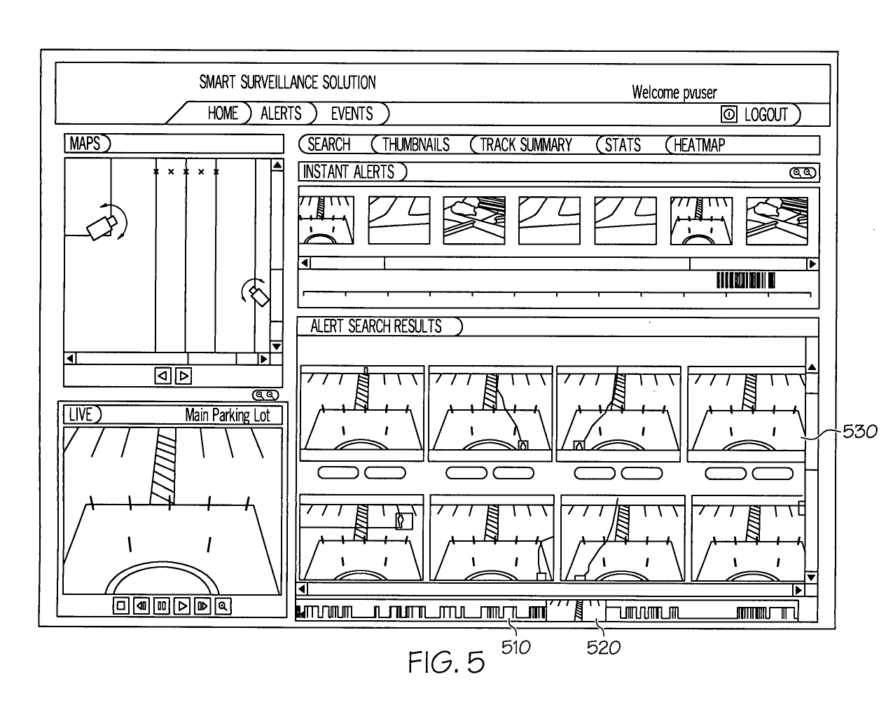

FIG. 5 shows the event thumbnail view. Here the user is browsing through the results of a search query. Element 510 shows the timeline of various events, each green bar represents an event, thus allowing the user to visually observe a pattern of events that have occurred over a period of time. Element 520 shows an event keyframe that pops up when the user performs a mouse-over operation on the event markers. Element 530 shows the keyframe that represents each event. The key frame is annotated with the trajectory of the object and the coloring of the trajectory indicates the direction of movement of the object.

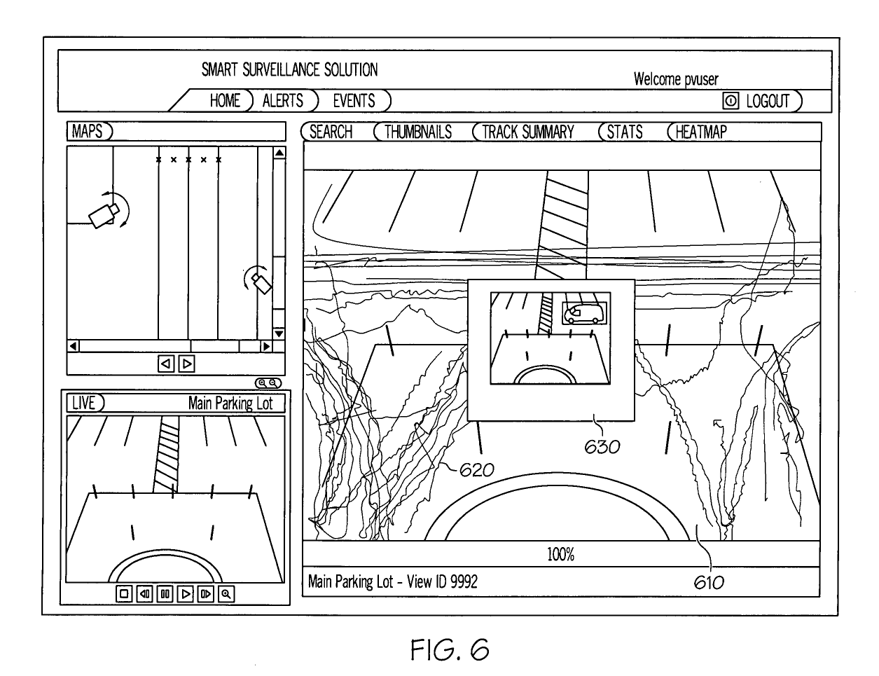

FIG. 6 shows the summary view of events. This view provides a spatial summary of the events the search results, thus providing the user with a visual pattern. Element 610 shows the keyframe overlayed with the tracks of objects. Element 620 shows the various tracks corresponding to events in the view. Element 630 shows the keyframe that pops up when the user performs a mouse over operation on one of the tracks. Rules that include annotating an input data stream with a boundary line may be specified, and an event is detected when an object crosses the boundary line.

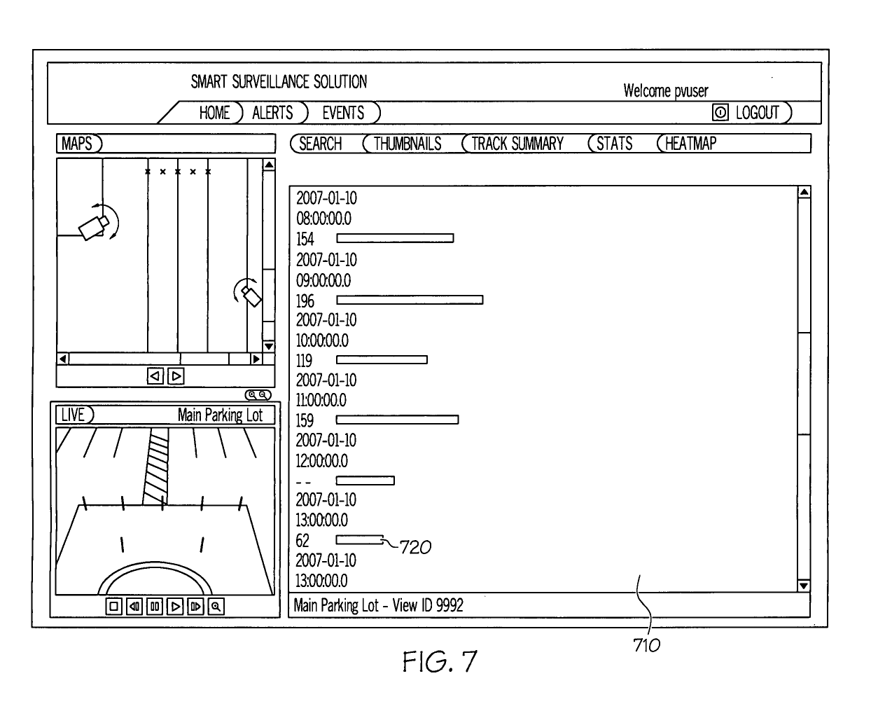

FIG. 7 shows a statistical view of events. This view provides a temporal distribution of events. Element 710 shows a series of bars at multiple points in time, for example 9 AM-10 AM, 10 AM-11 AM, soon in some fixed interval. In element 720, each bar represents the number of events that occurred in that time interval, the height of the bar corresponds to the number of events.

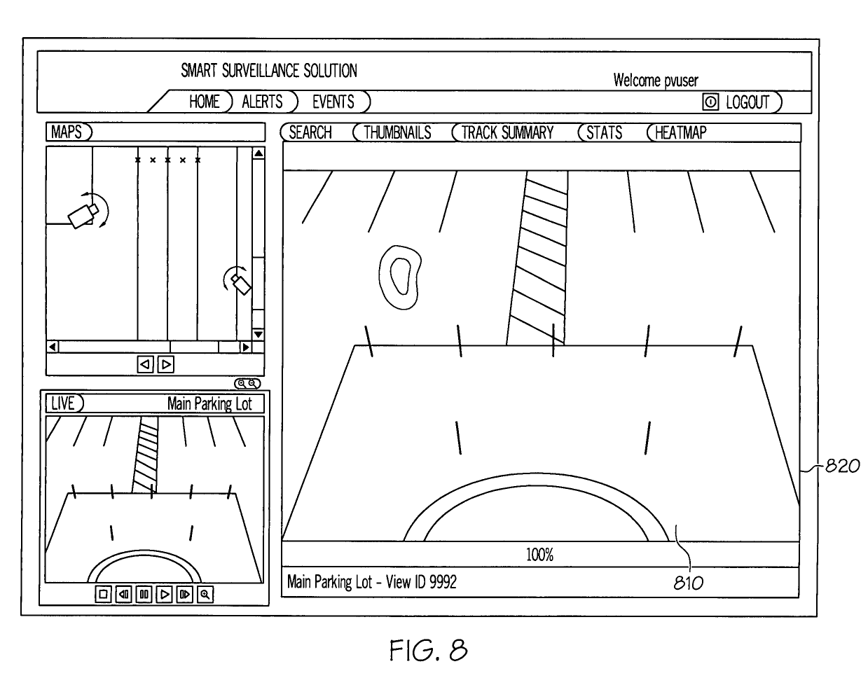

FIG. 8 shows a heatmap view of events. A heatmap shows the spatial distribution of some parameter of the activity. For example, dwell time in front of a shelf at a retail store. Element 810 shows a keyframe with color patterns overlaid on it, representing the summary of the parameter. Element 820 shows varying color representation where the intensity of the color represents the value of the parameter.

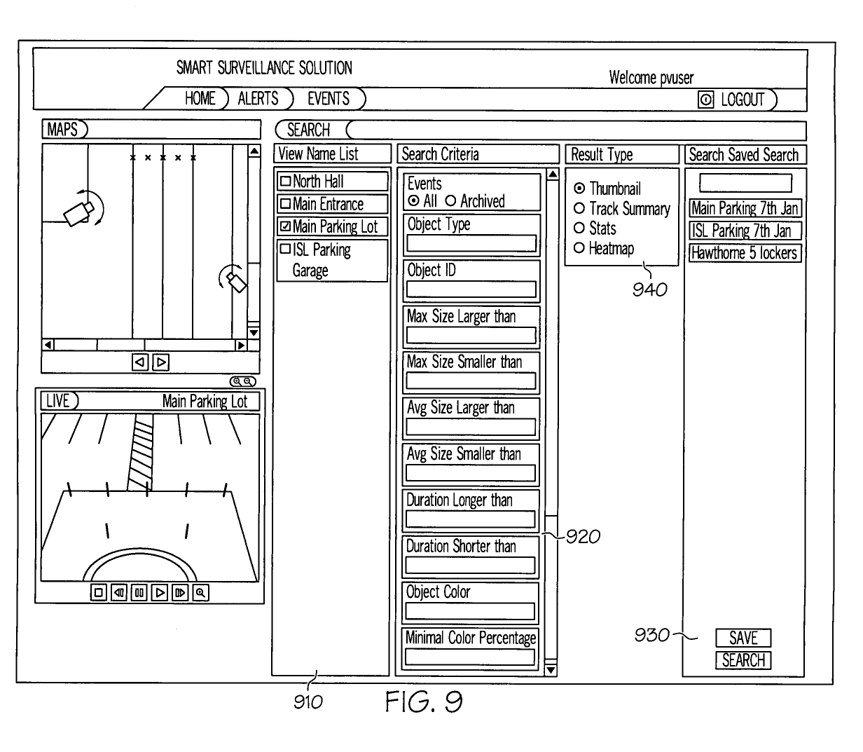

FIG. 9 shows the search interface through which the user can query the system. Element 910 shows the various cameras in the system and the user can select one or more cameras as the target of the search. Element 920 shows the various attributes on which the user can choose to launch the search. Element 940 shows the various visualizations that the user can choose, for example (thumbnail, track summary, heatmap or statistic view). Element 930 shows the various searches that have been saved by this user and provides the user with the capability to save a search.

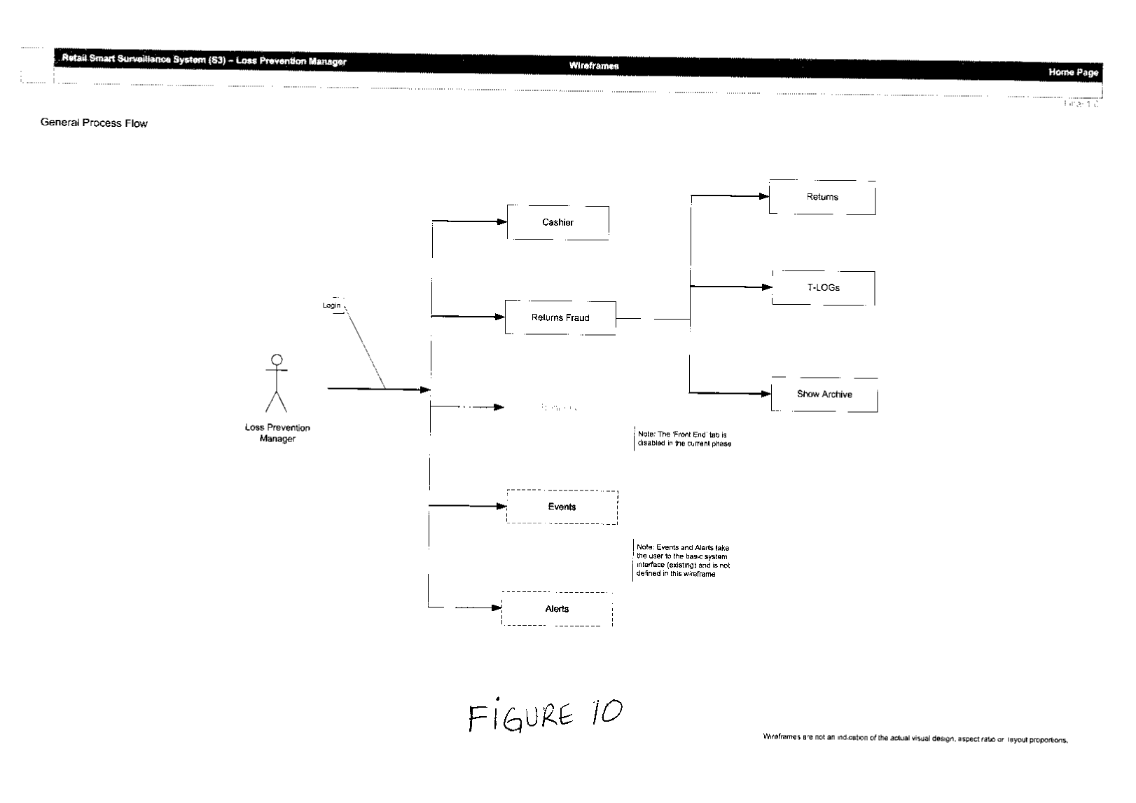

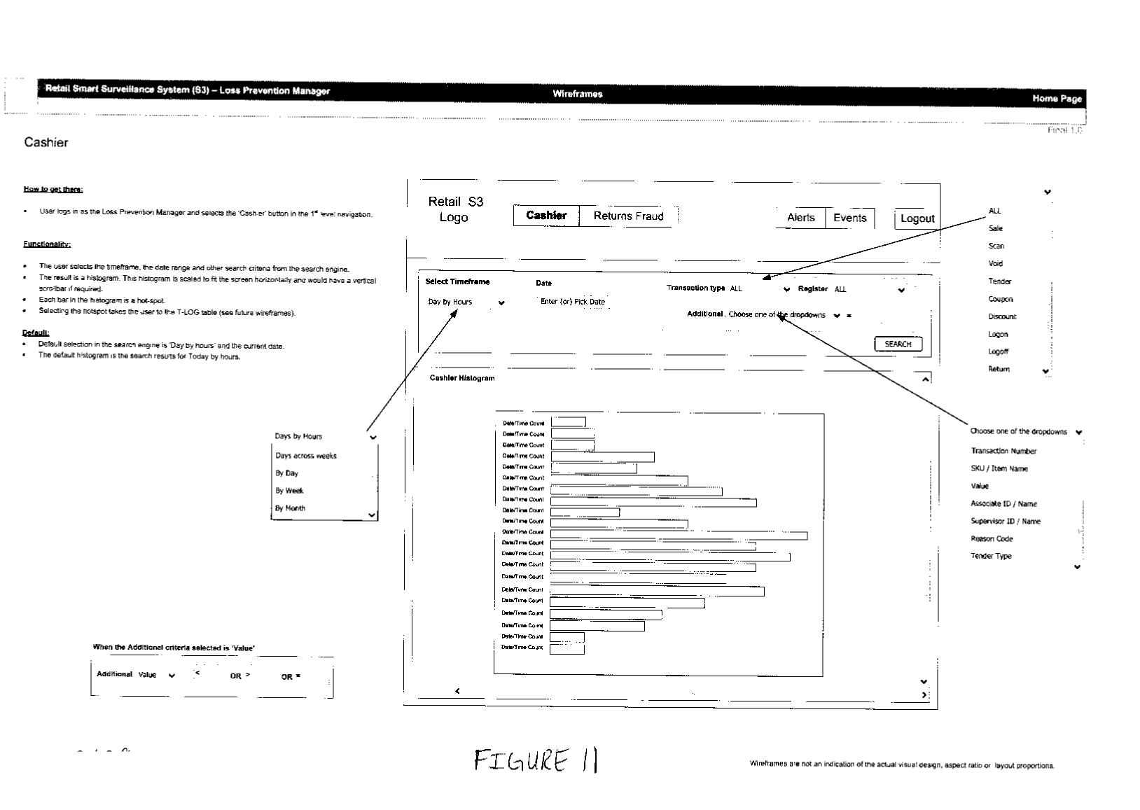

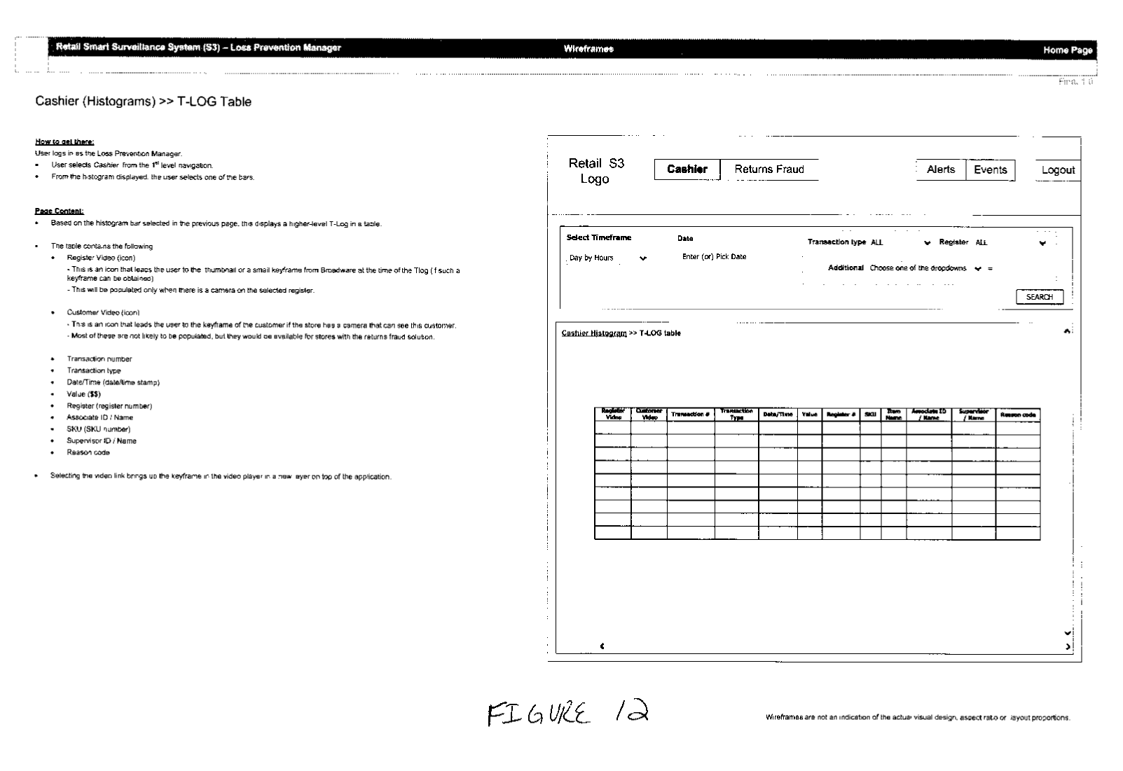

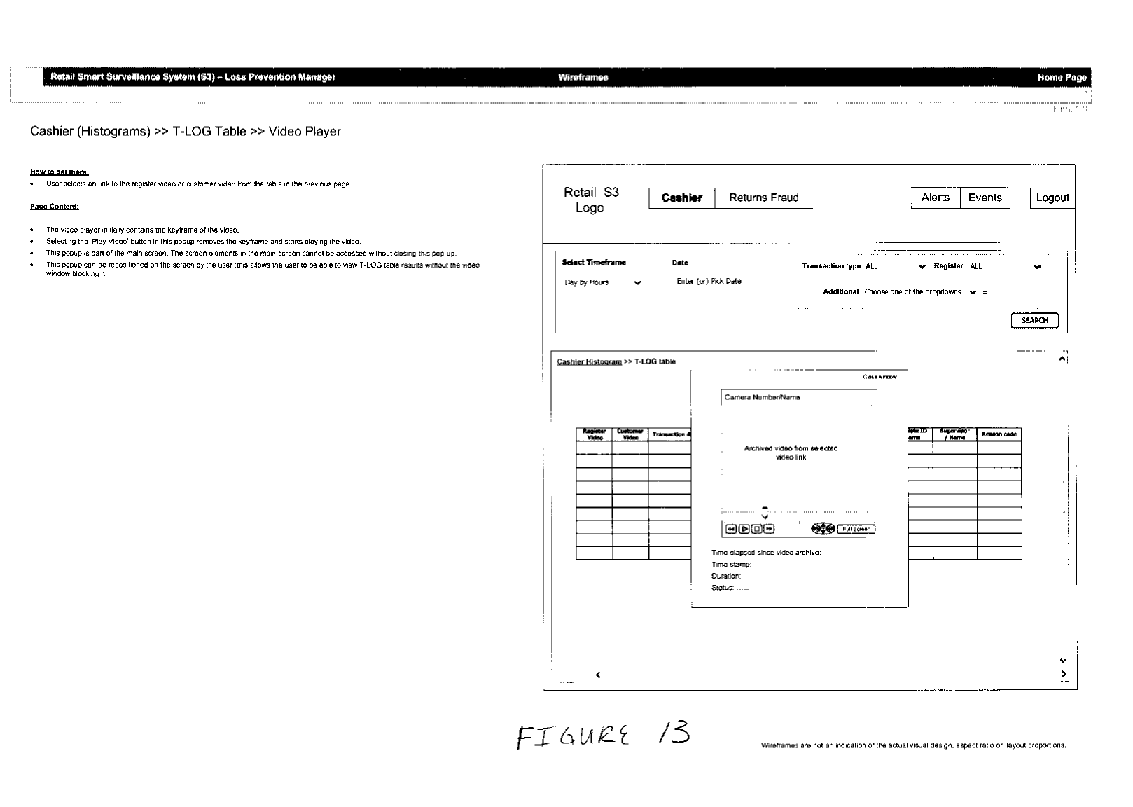

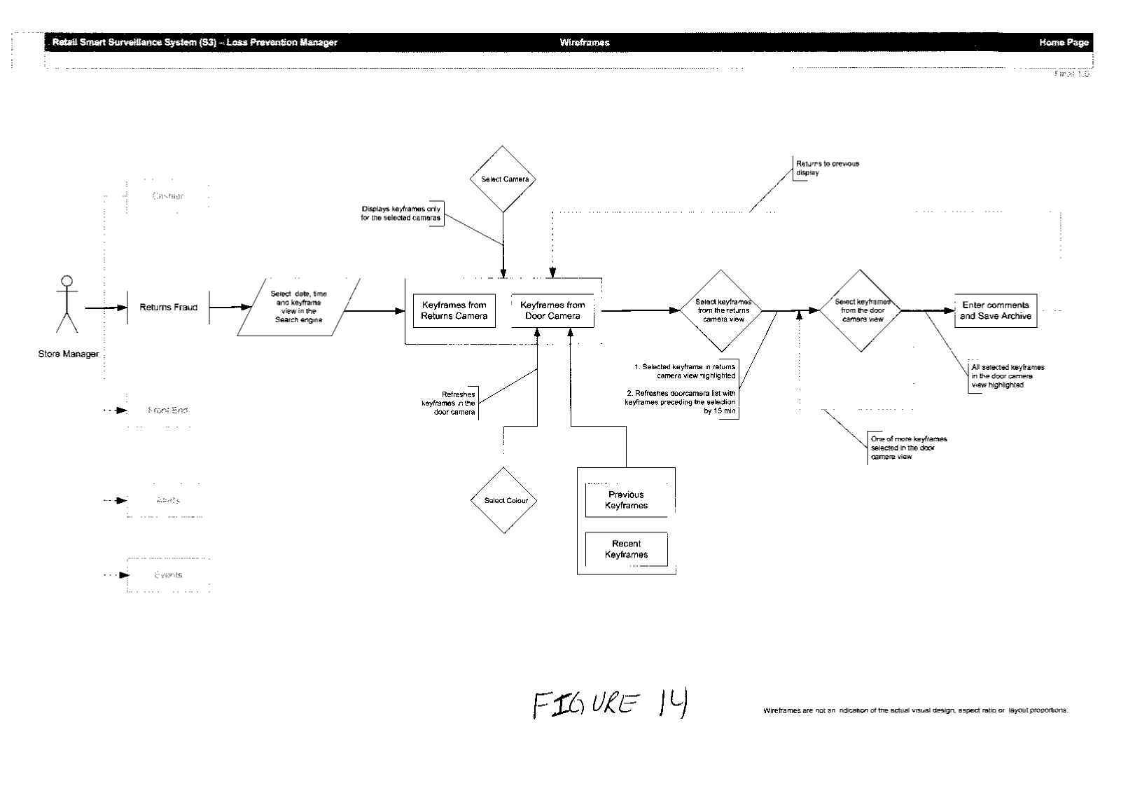

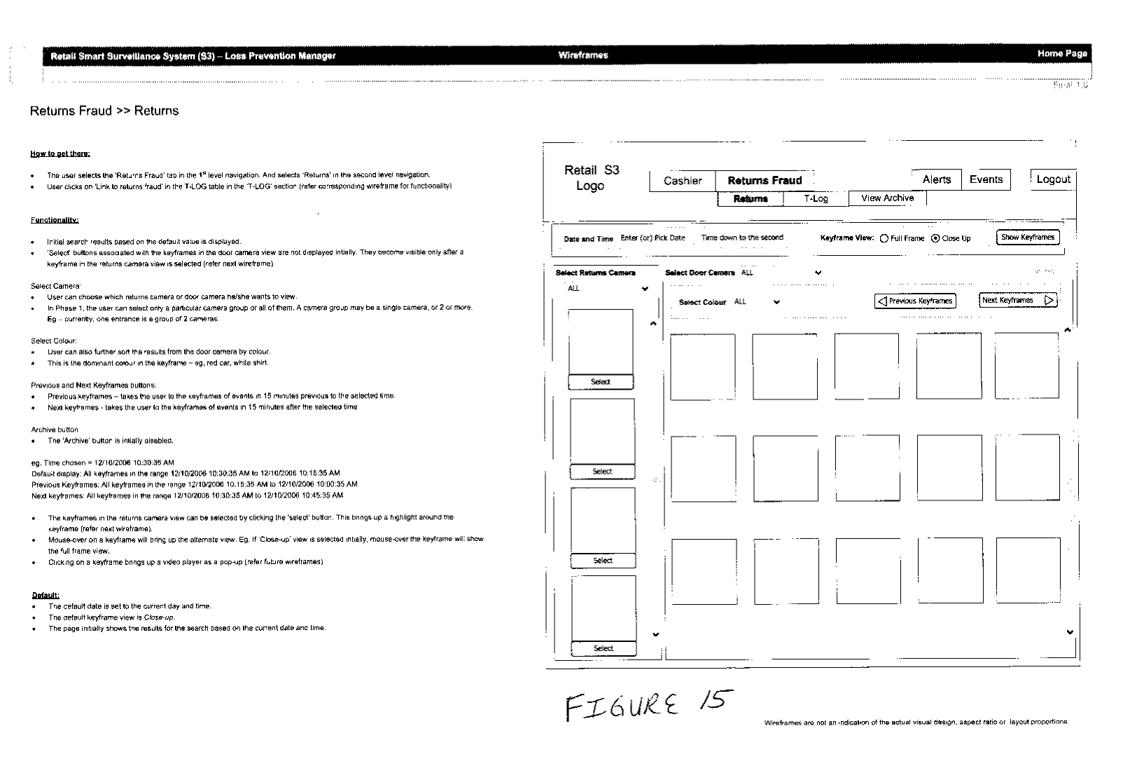

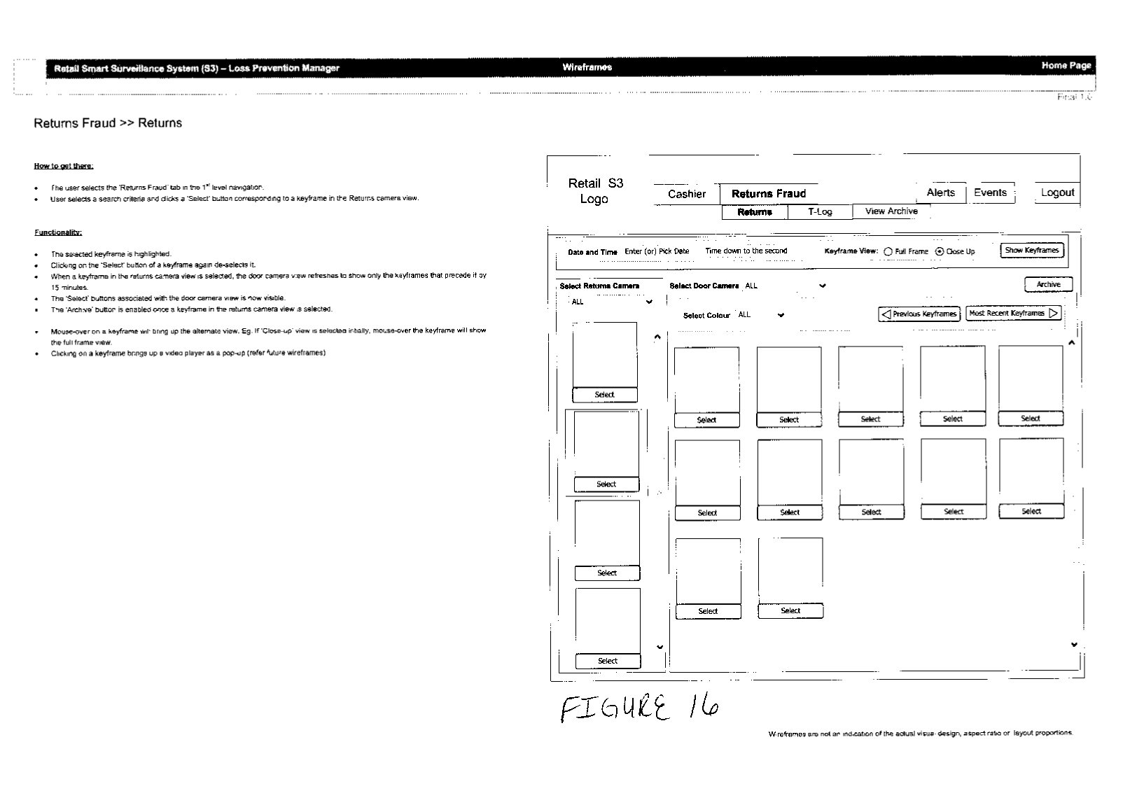

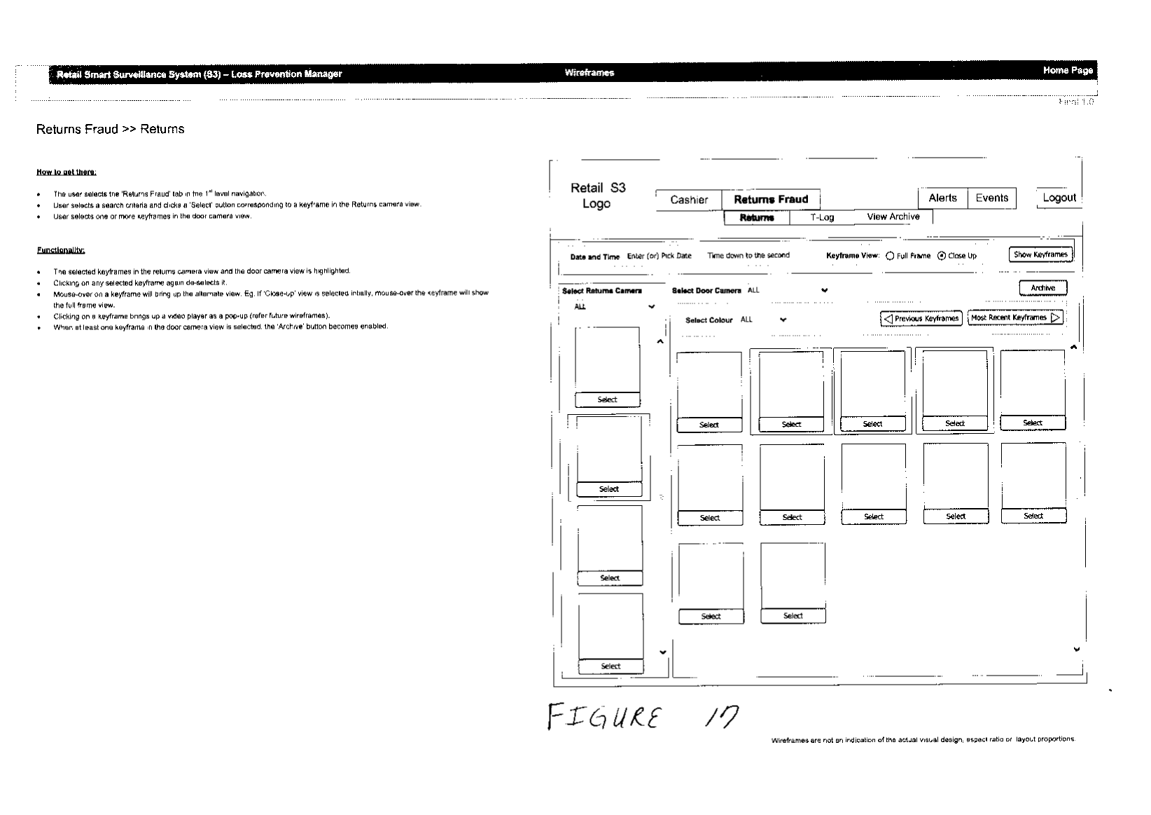

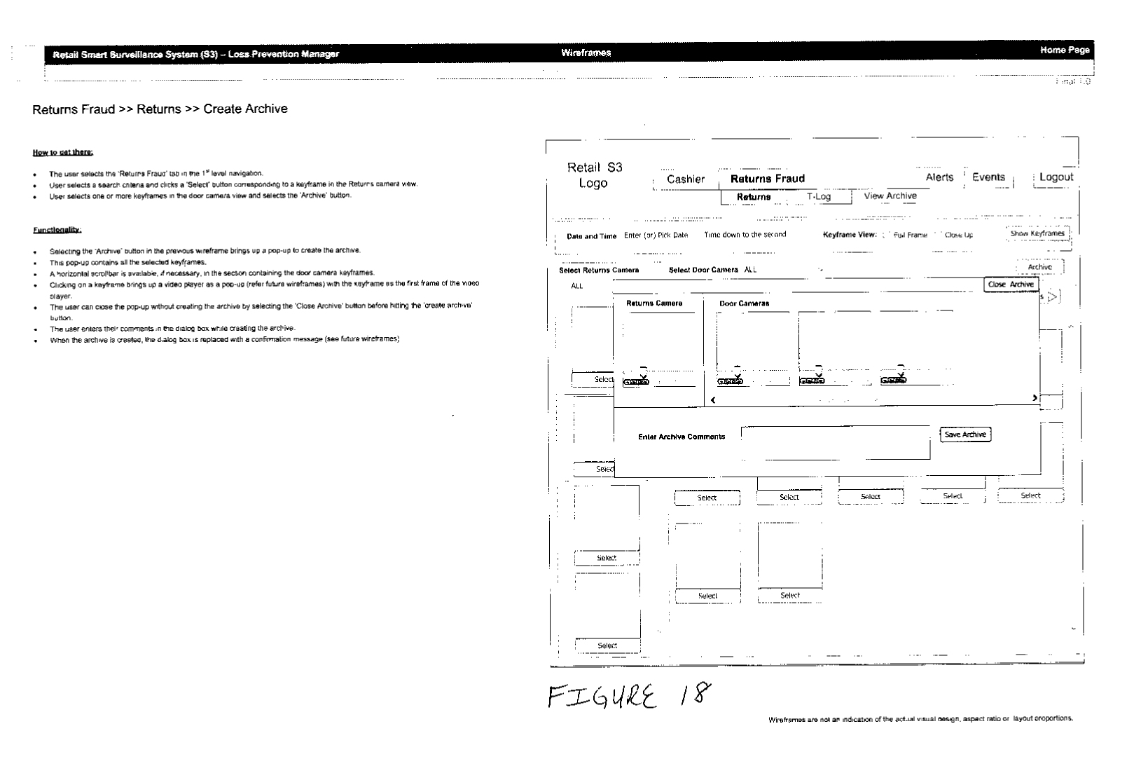

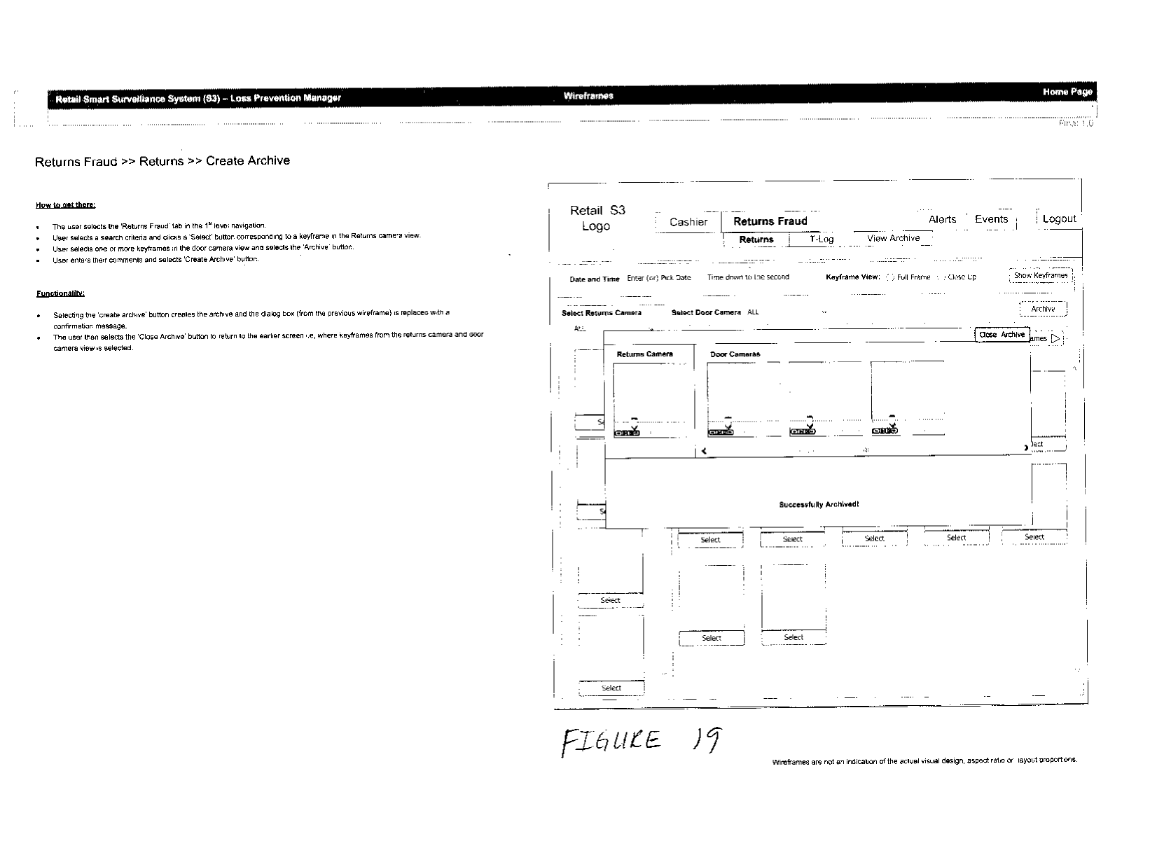

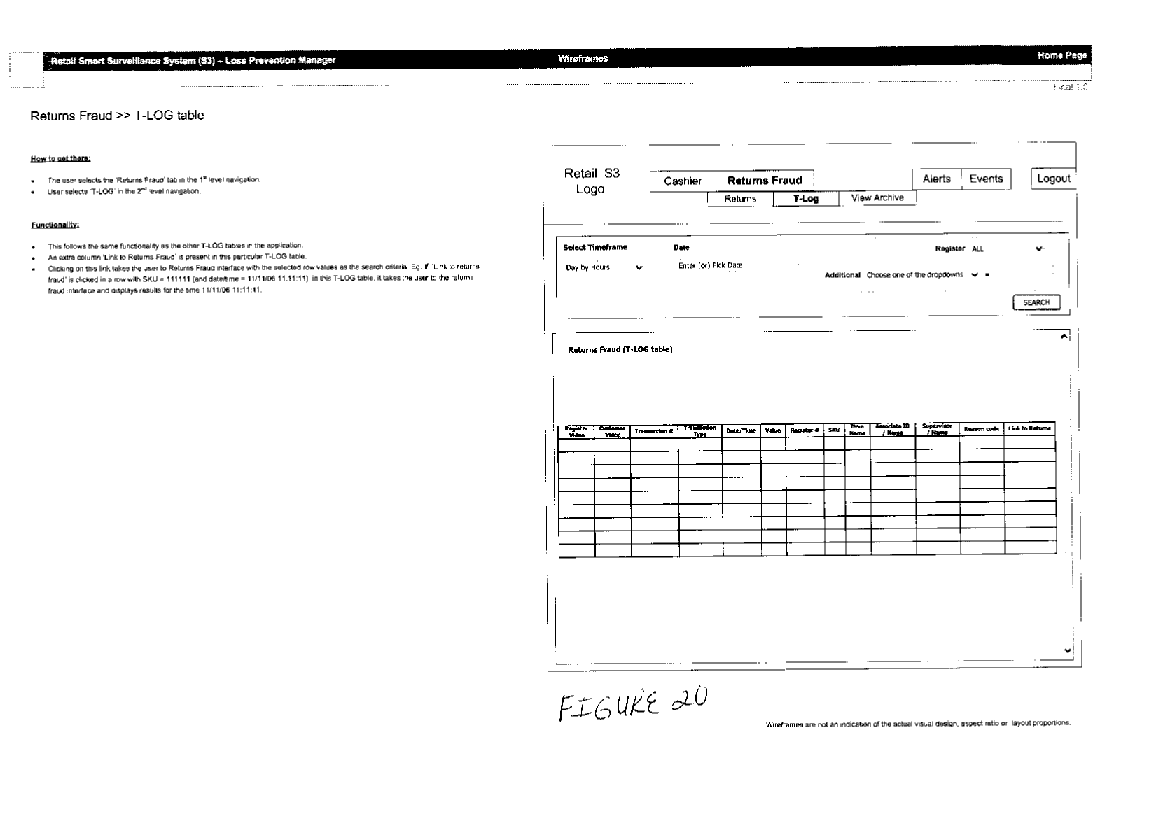

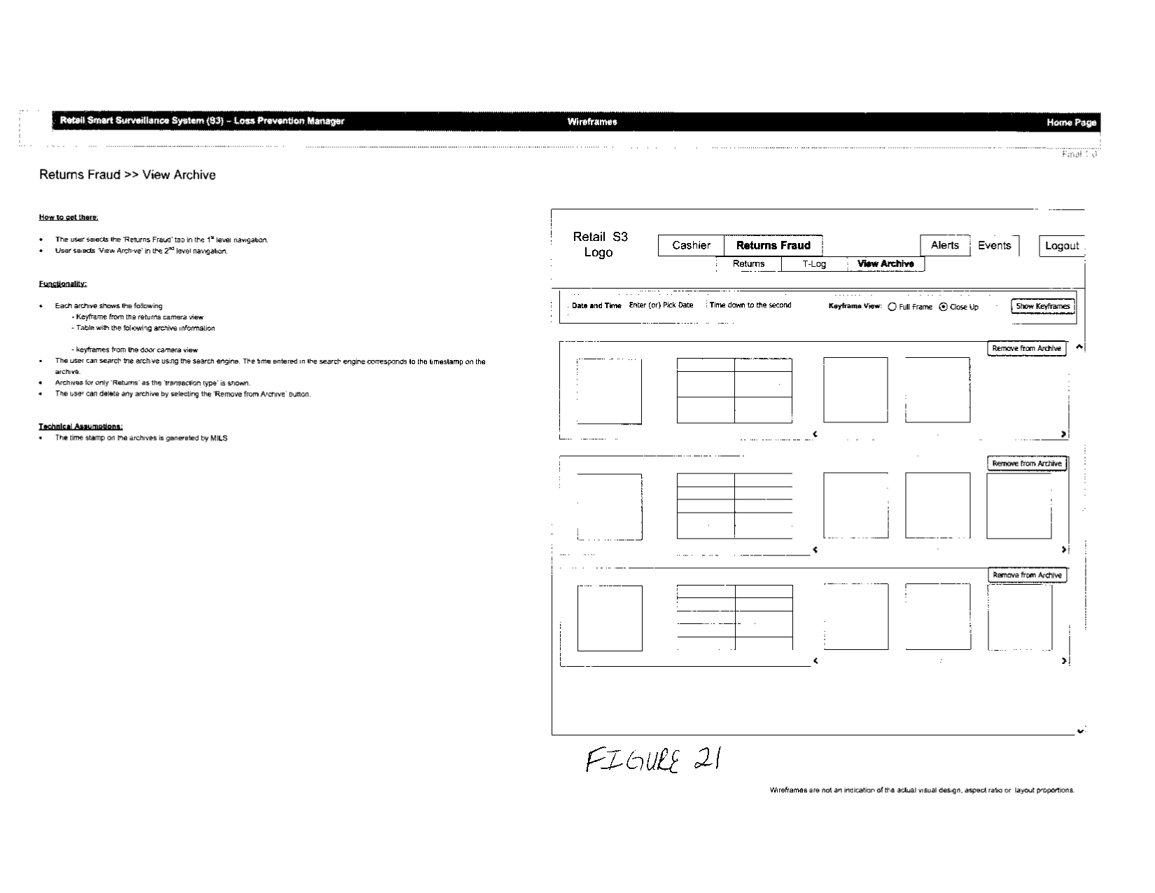

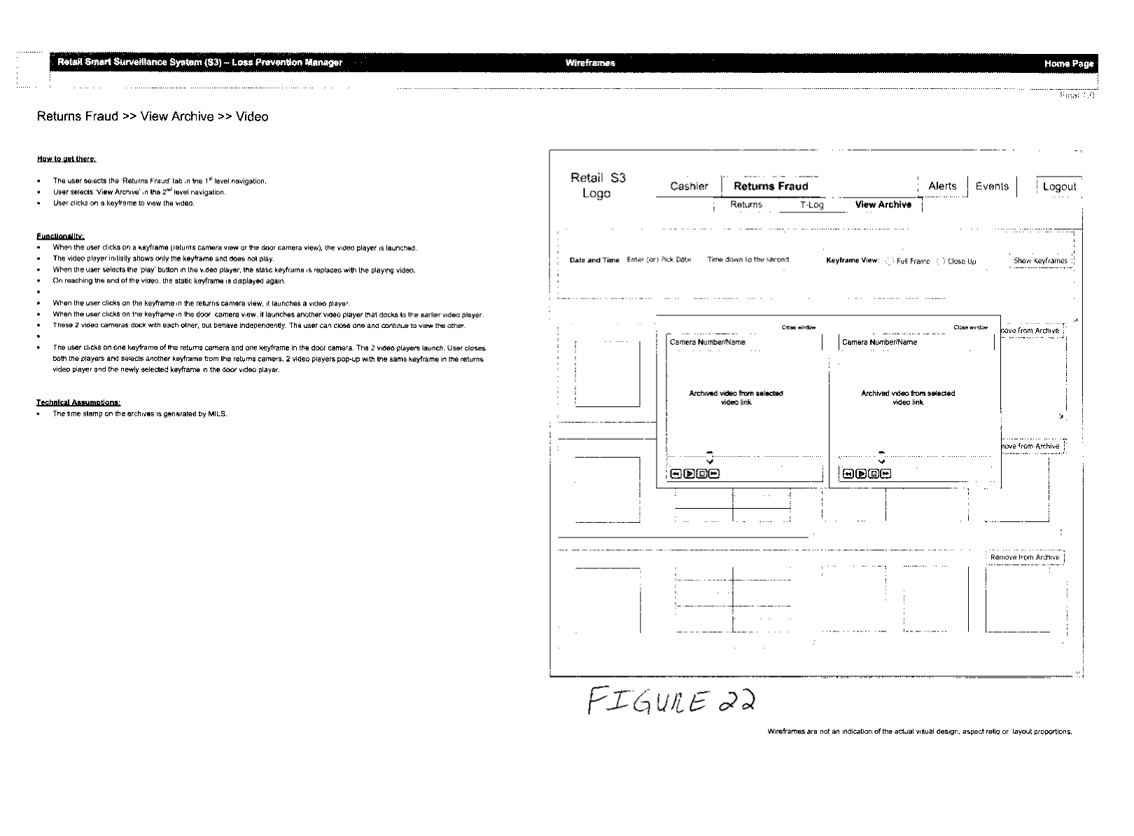

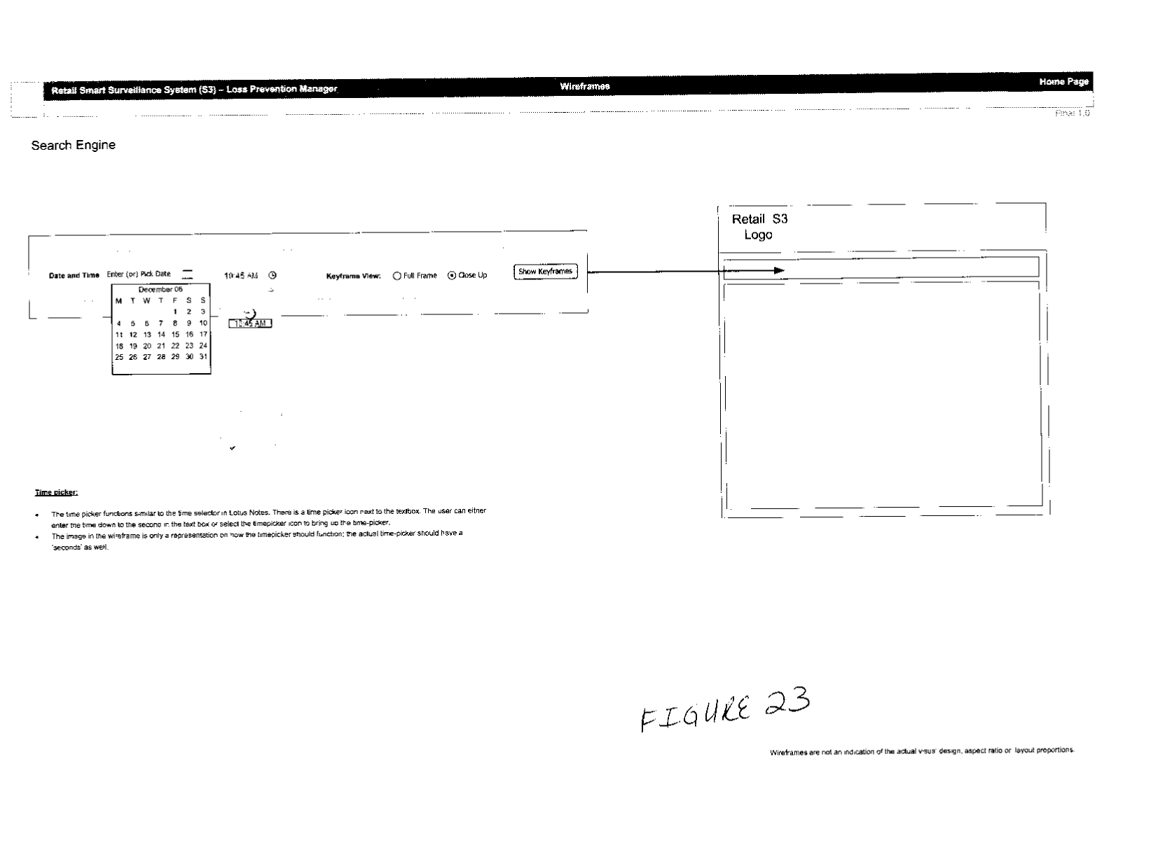

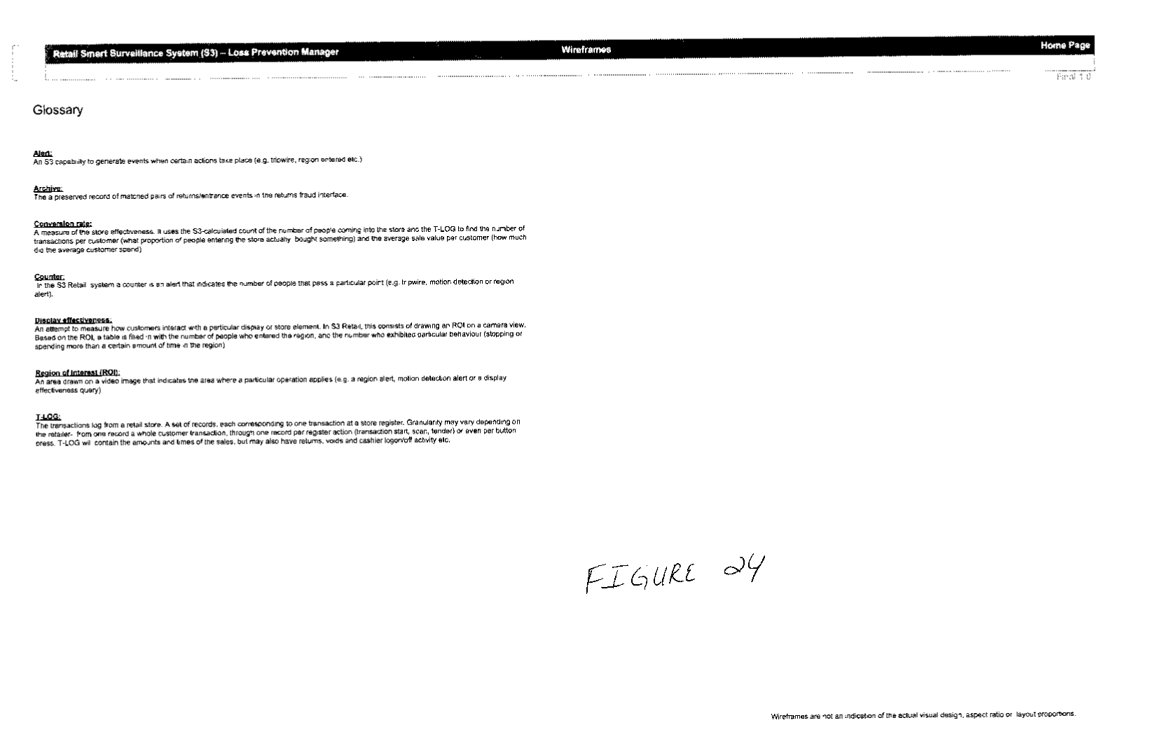

FIGS. 10-24 depict loss prevention management aspects of the present invention. Reduce the risk of loss in key retail areas such as cashier fraud and returns fraud. The invention compares video stream with transaction telemetry:

Integrates with existing systems

Unlimited transaction query basis

Synchronization of video with transaction telemetry

Detection of questionable activity by cashier personnel

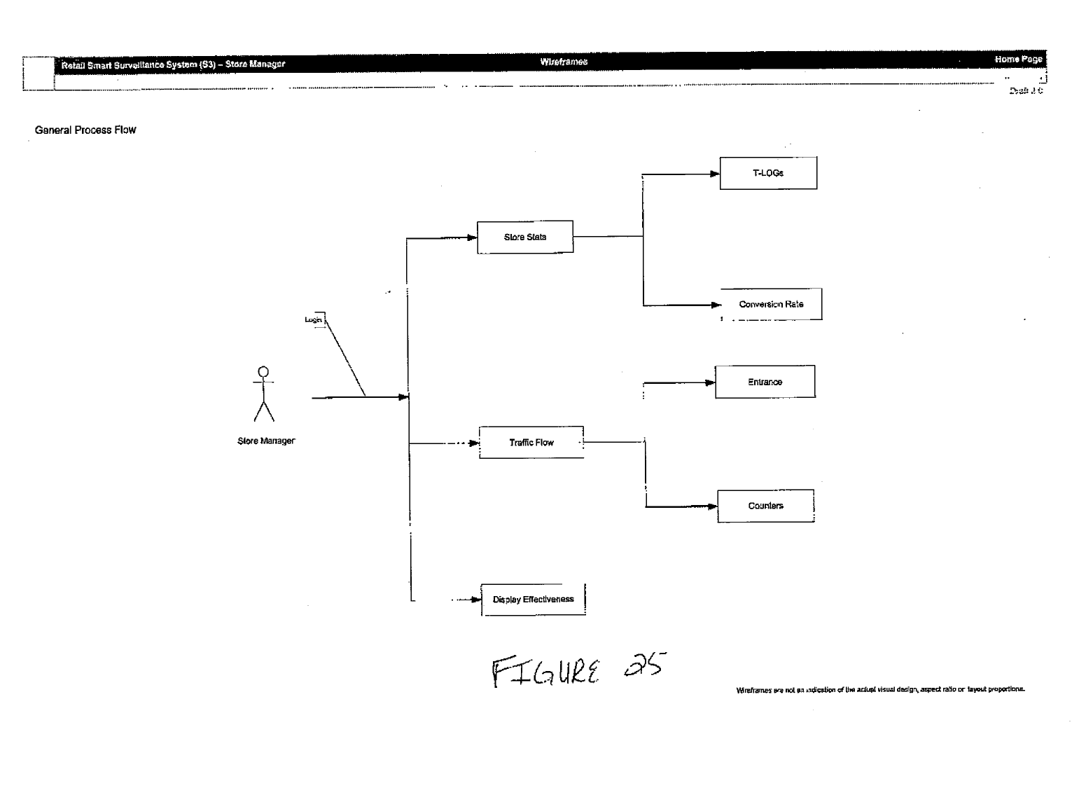

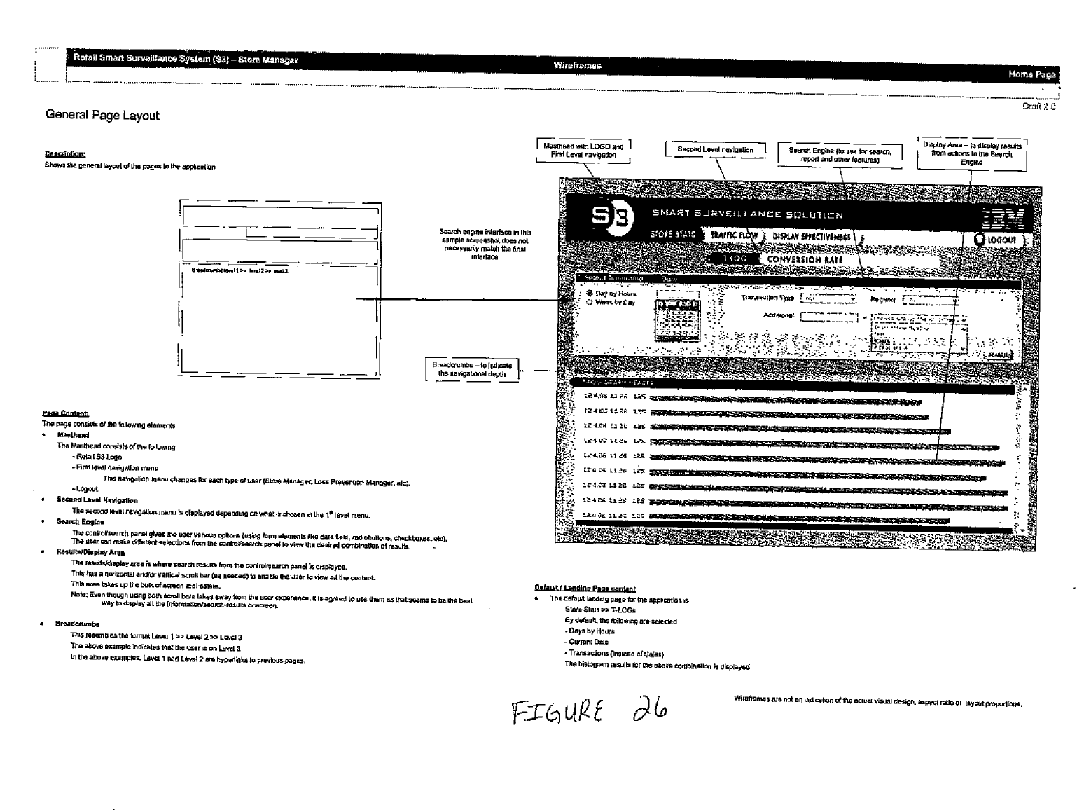

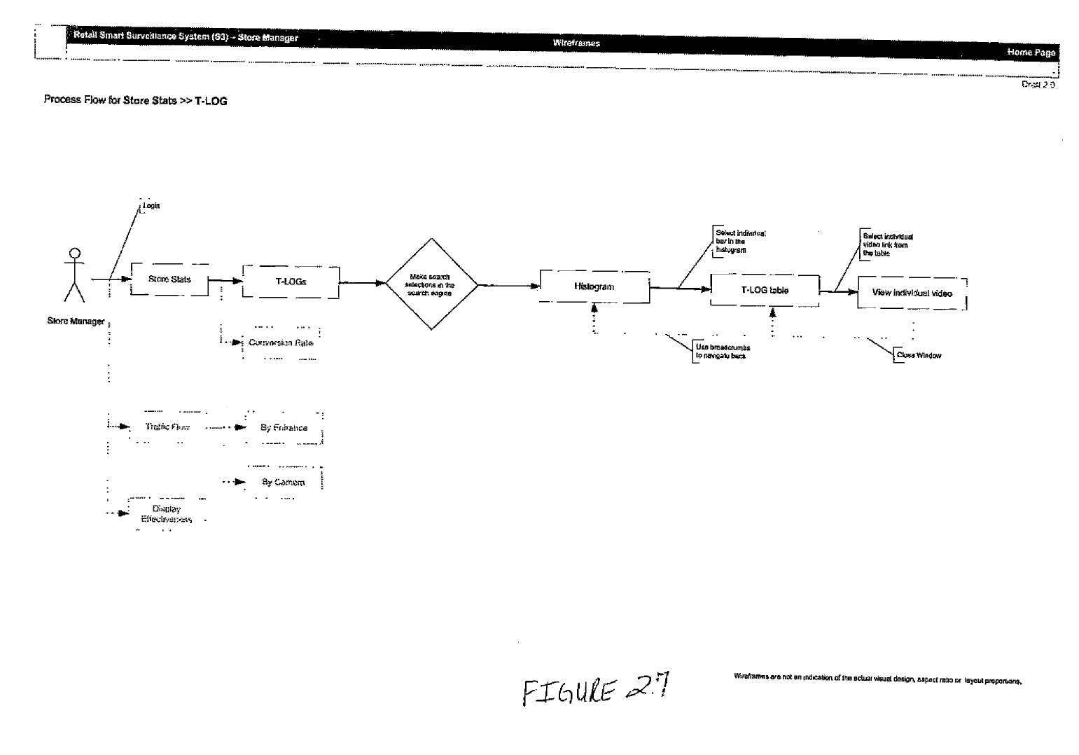

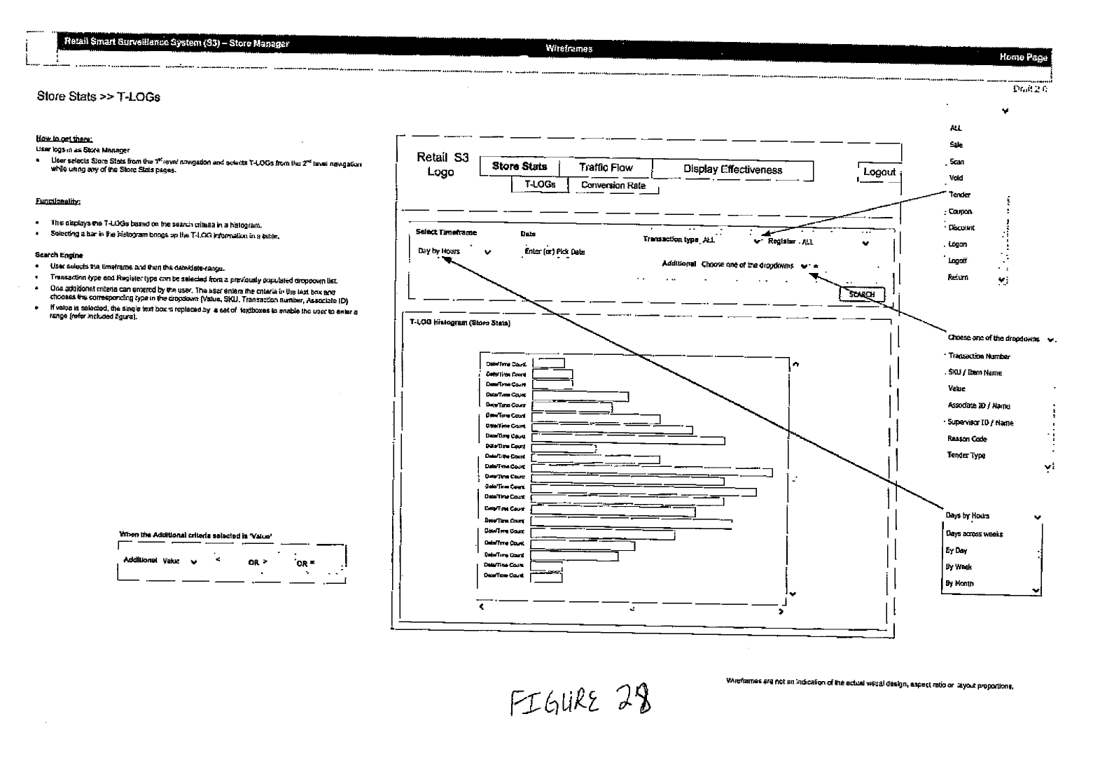

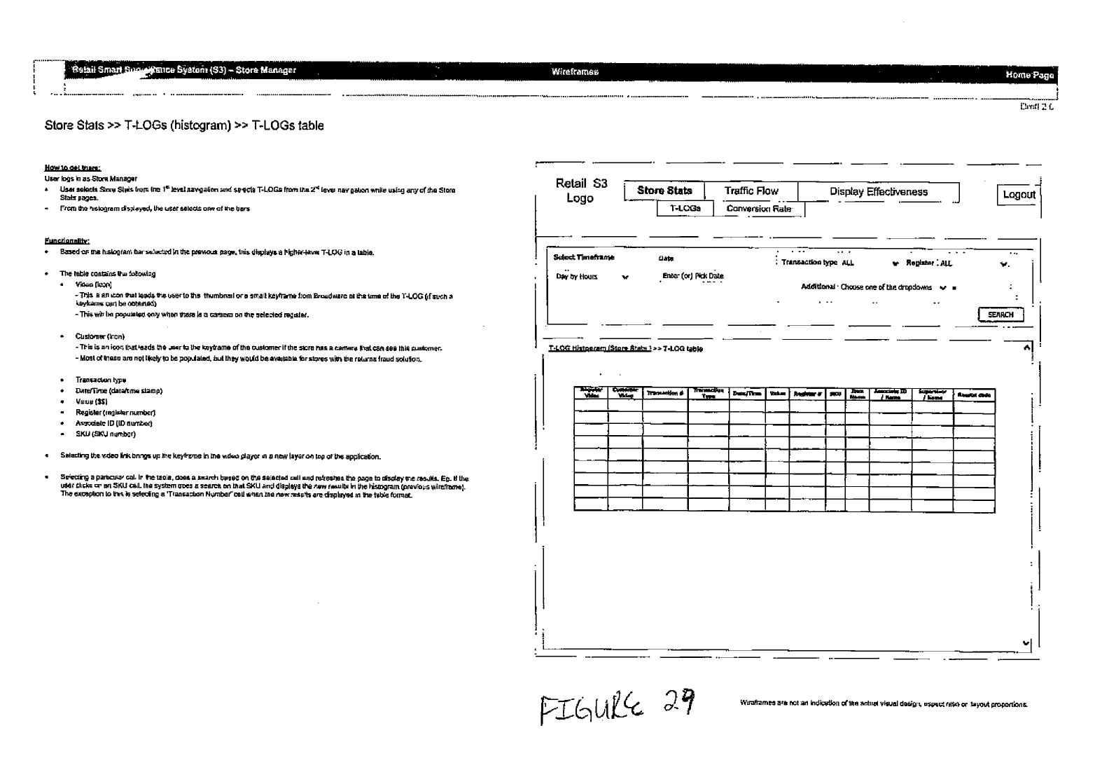

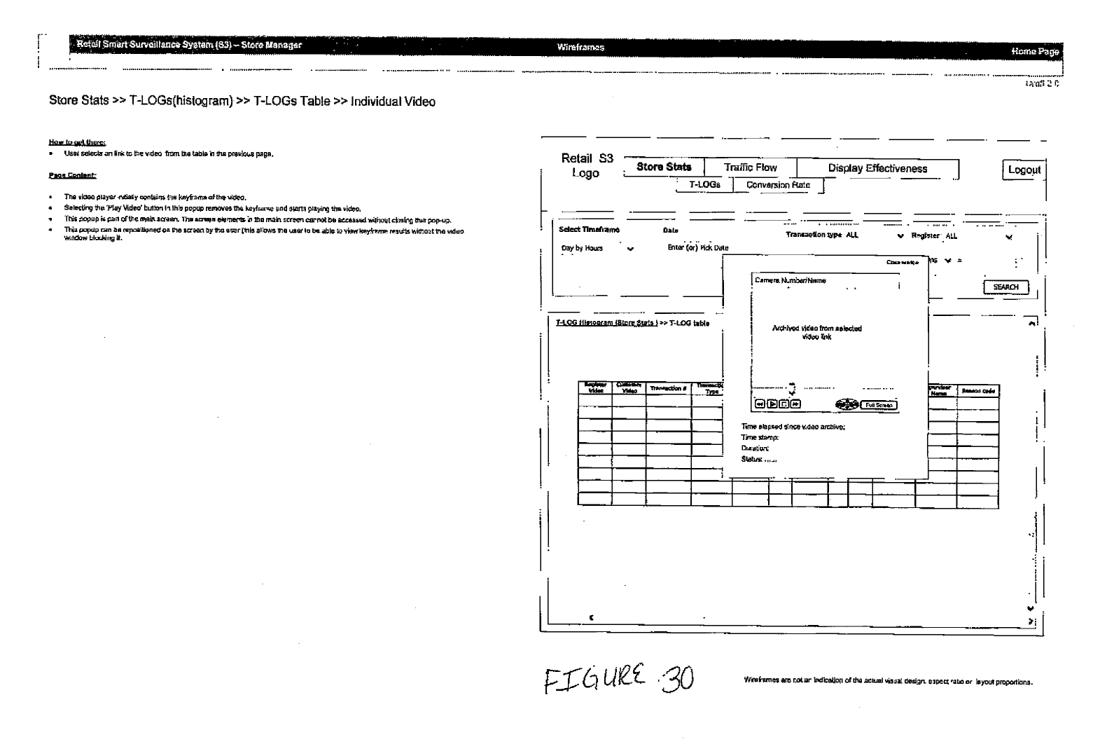

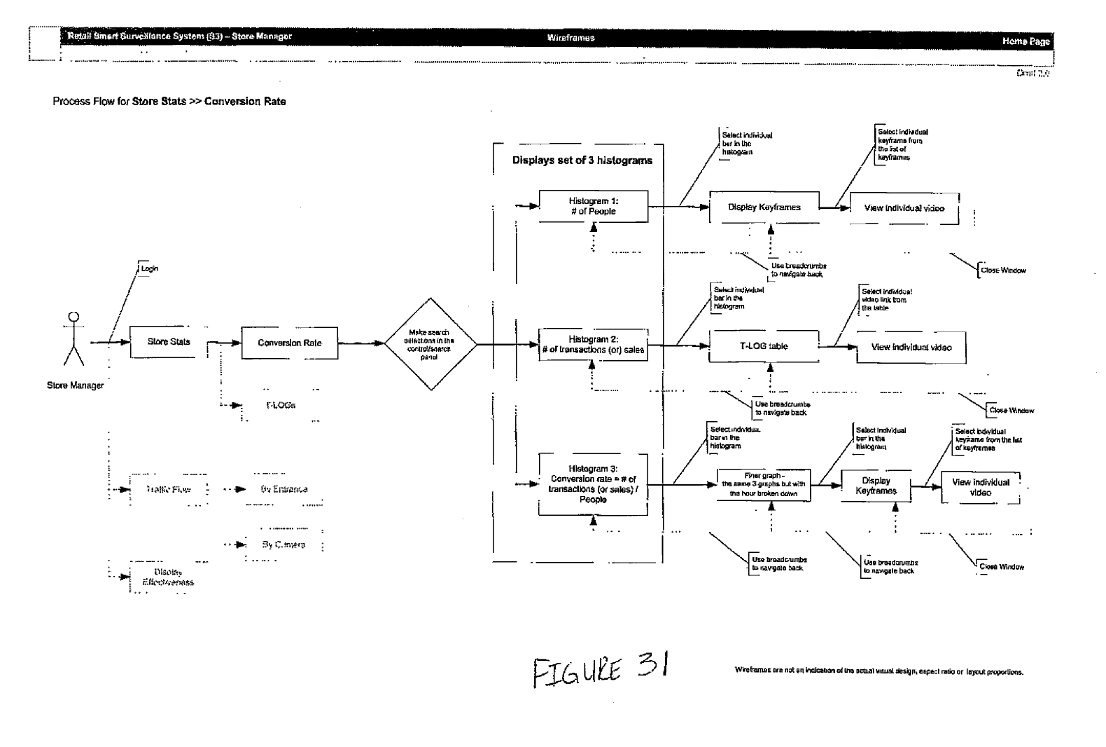

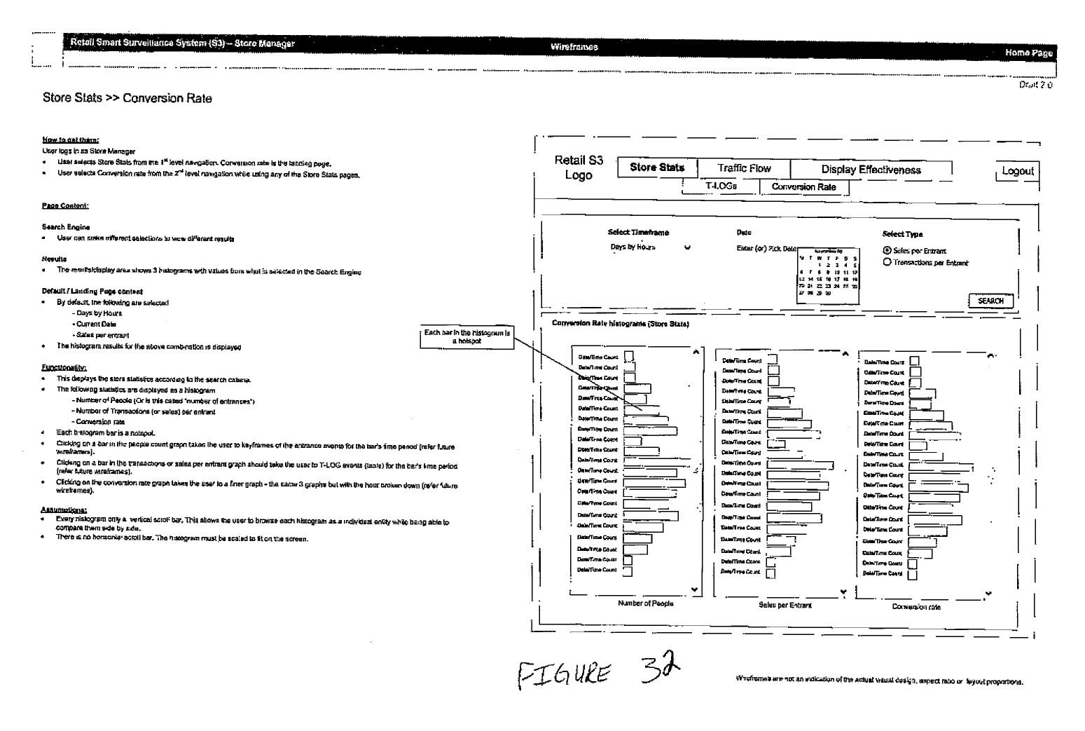

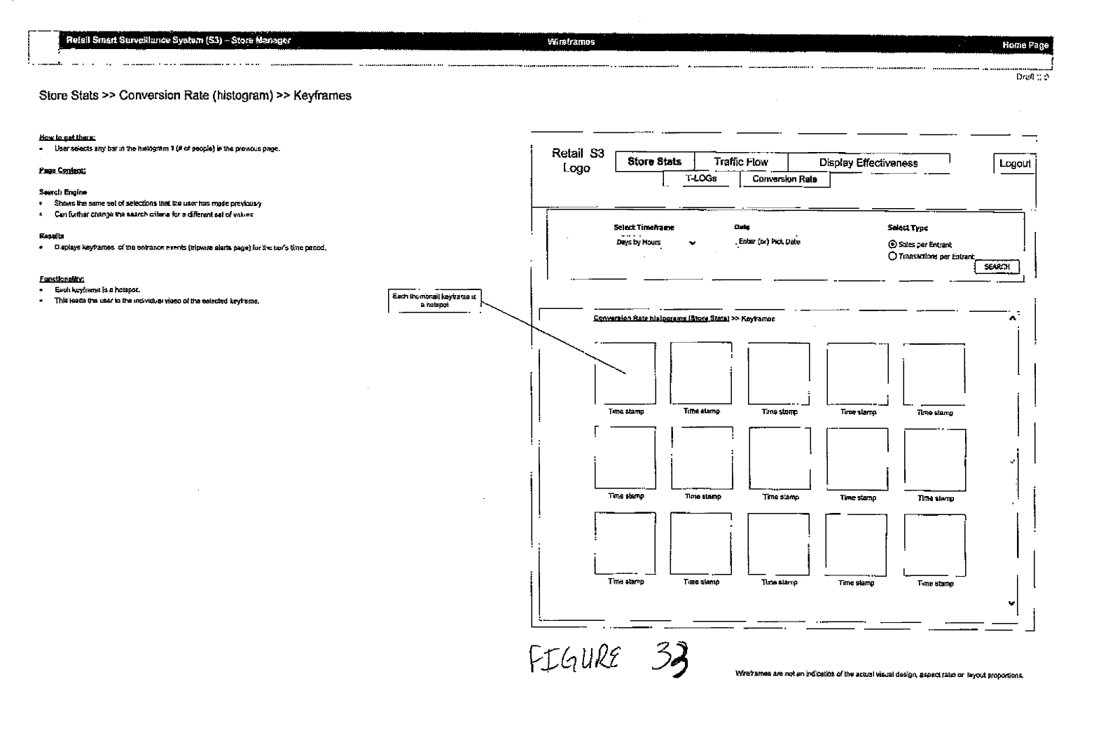

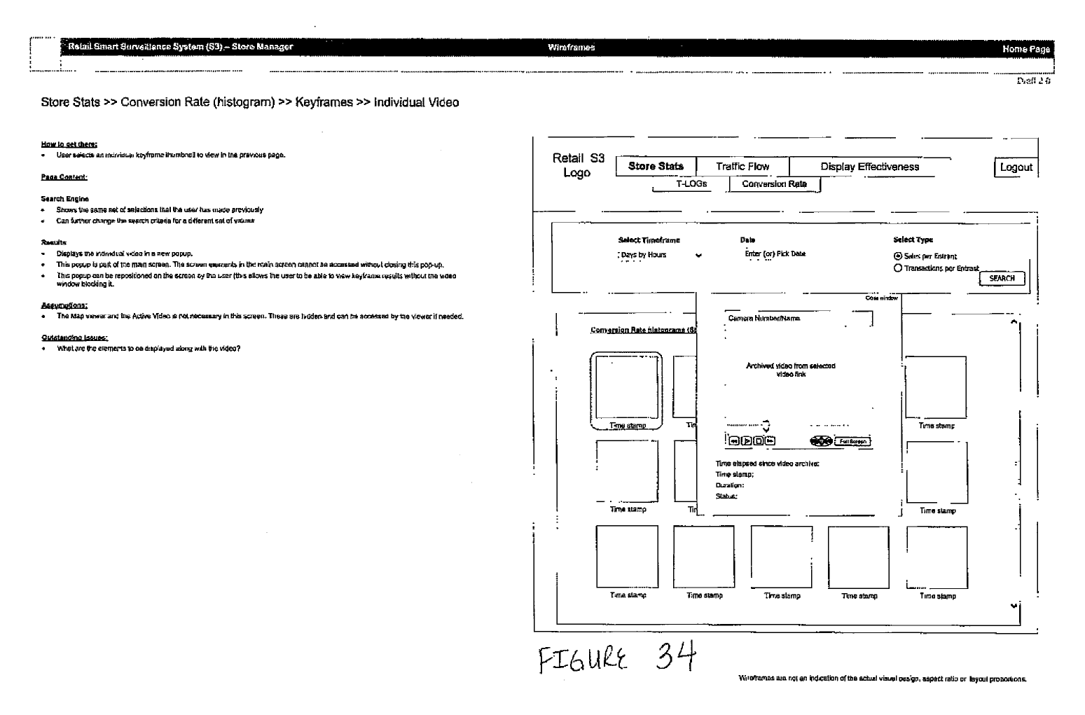

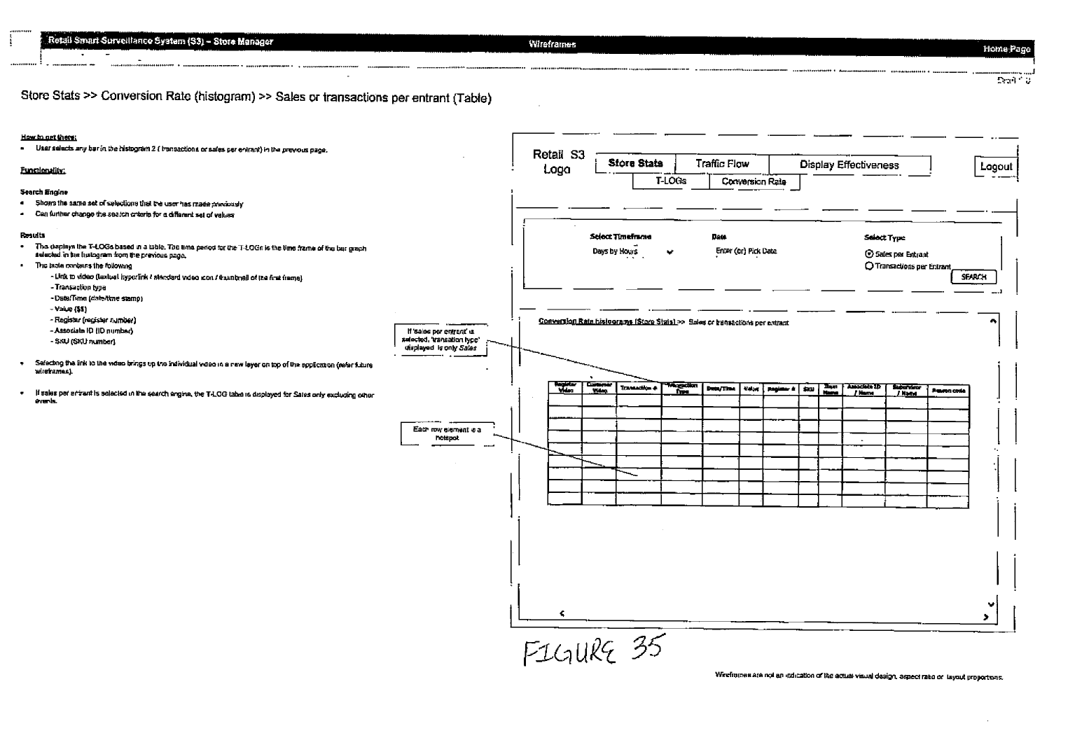

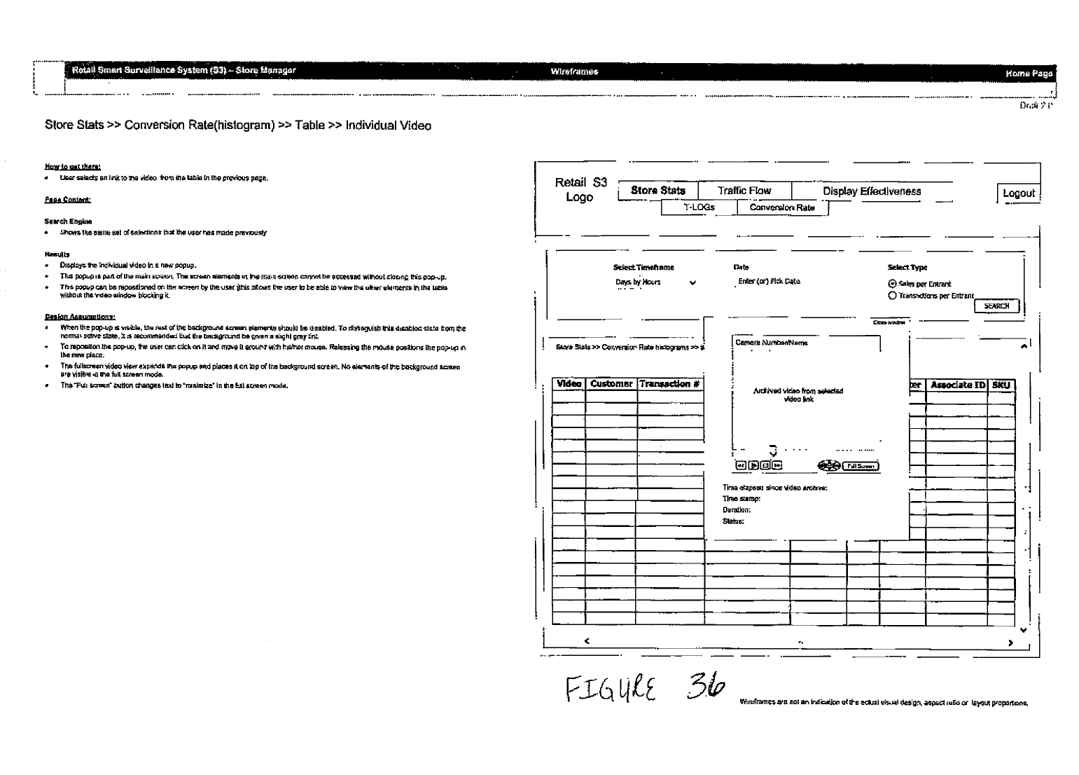

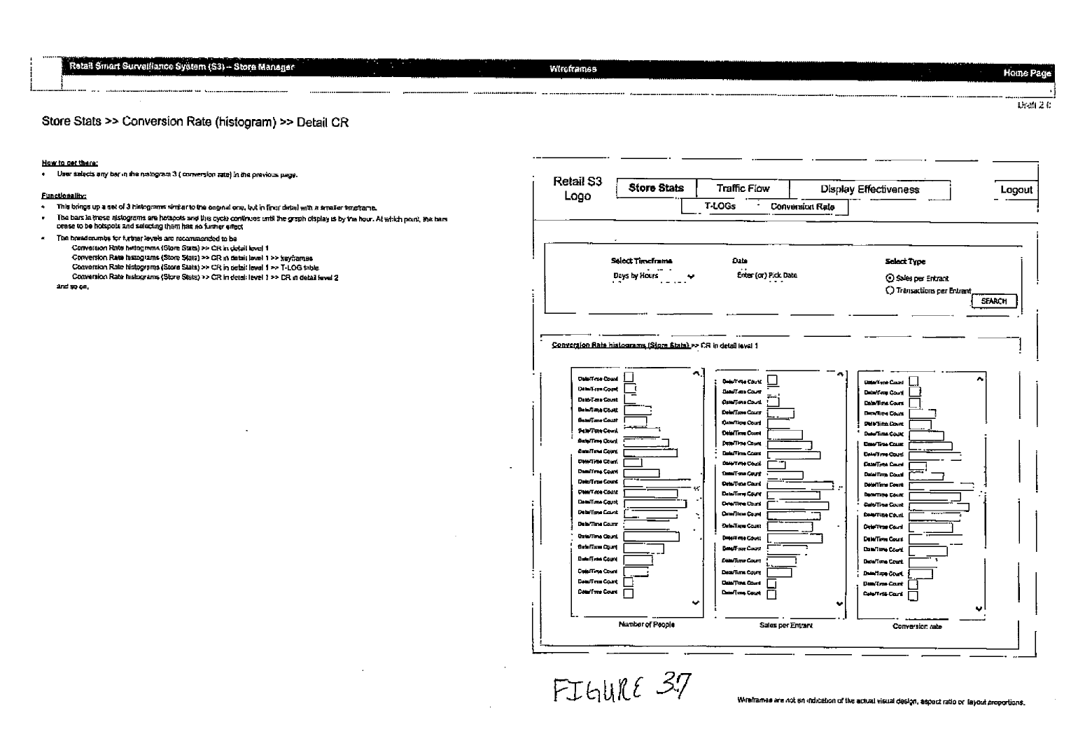

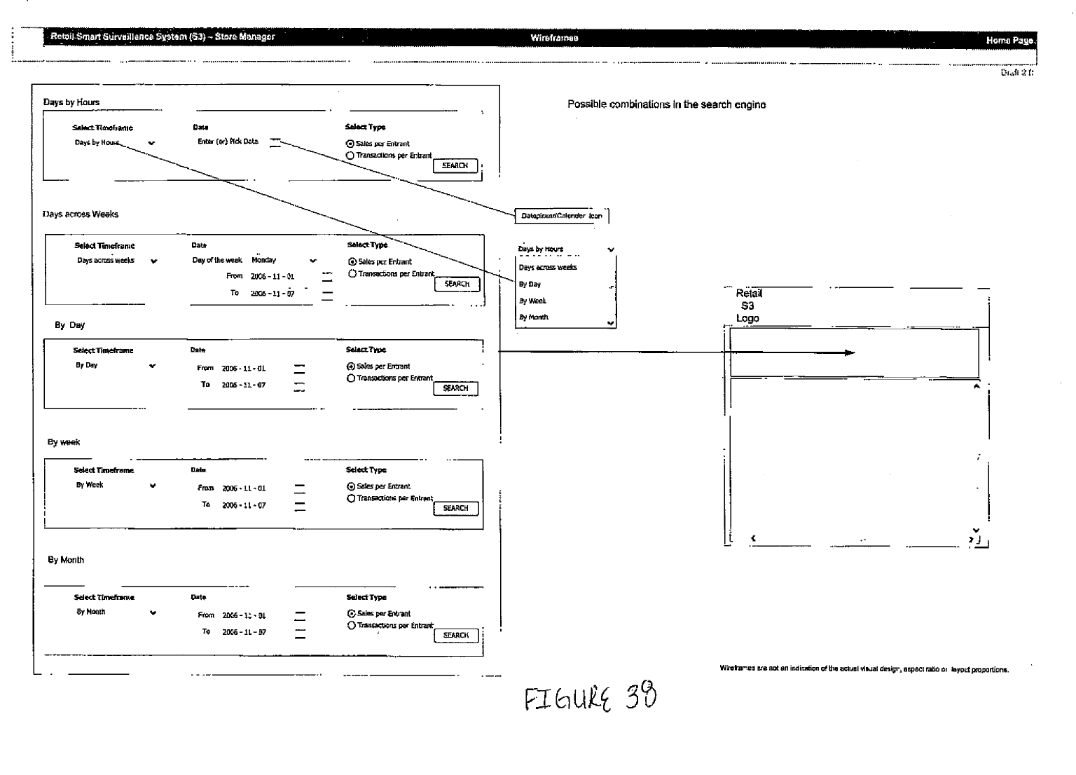

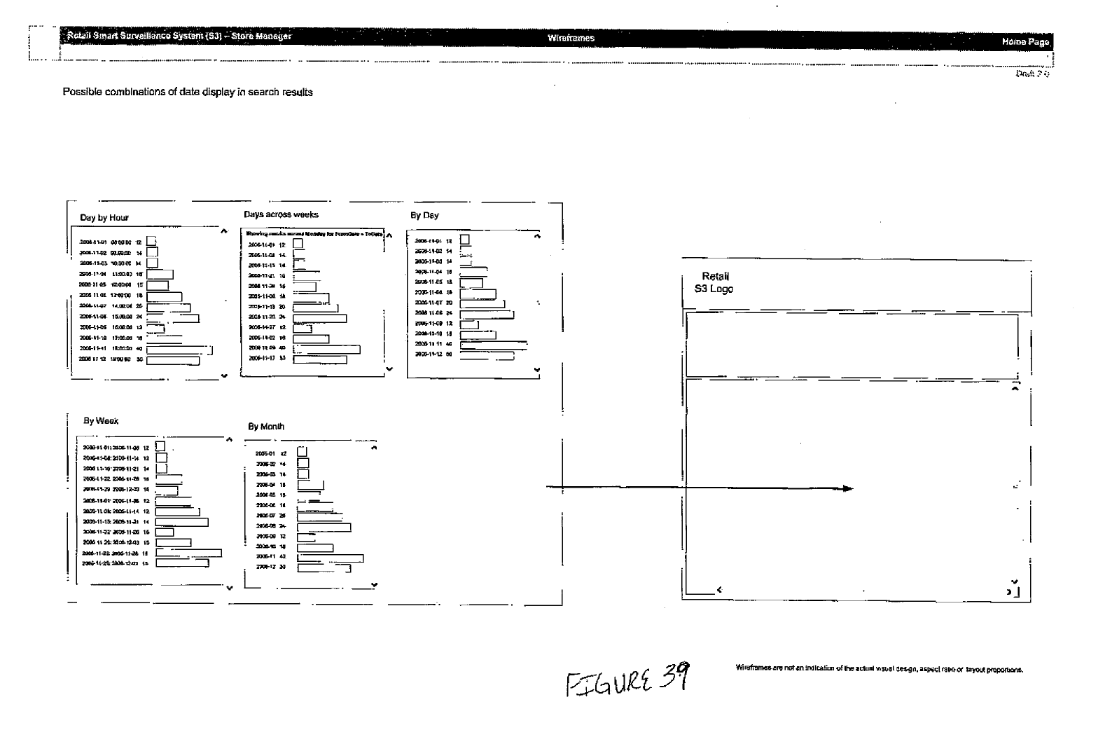

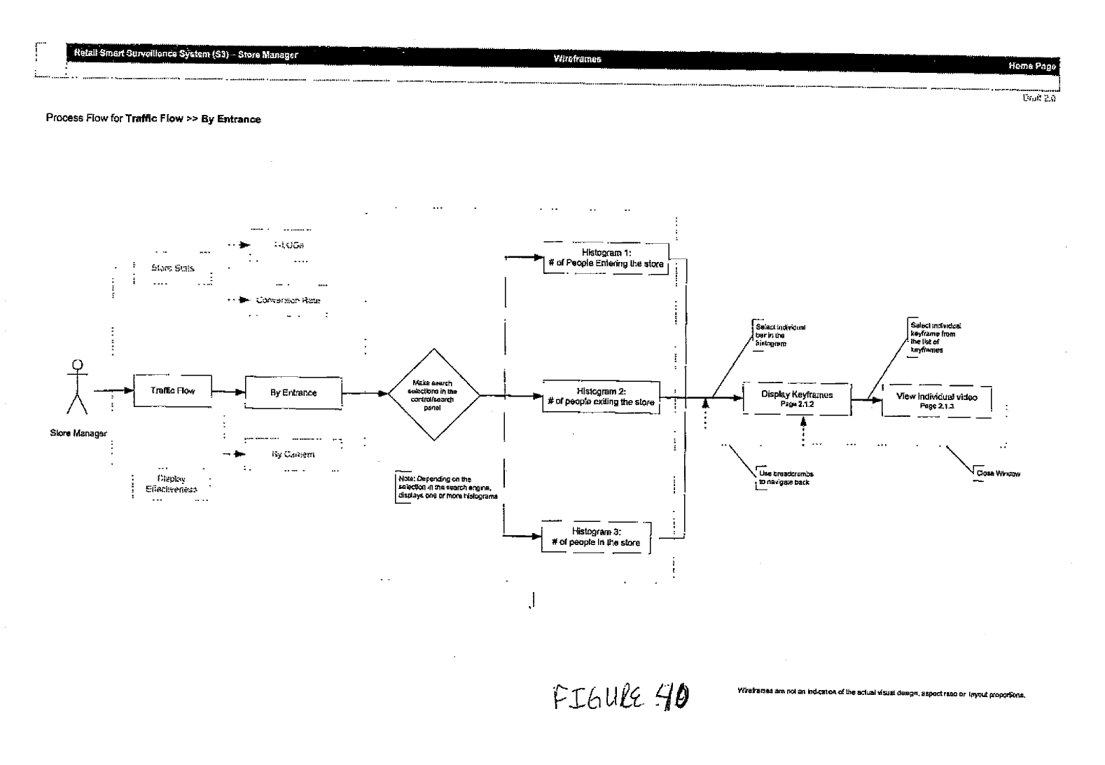

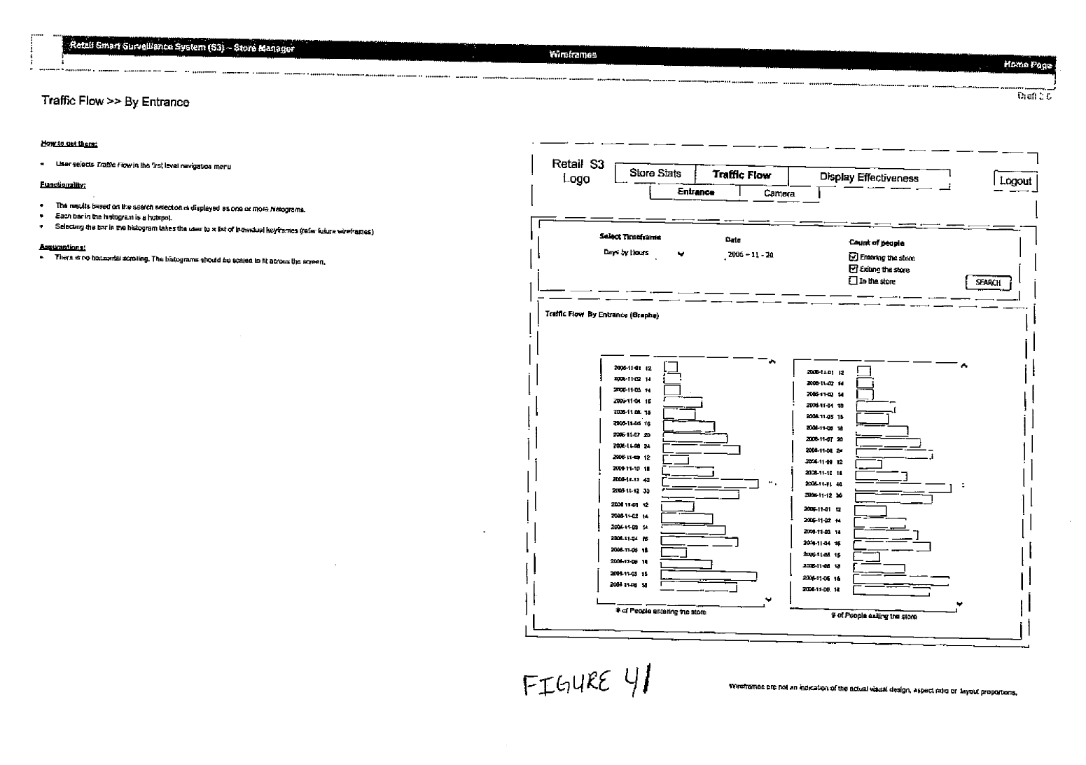

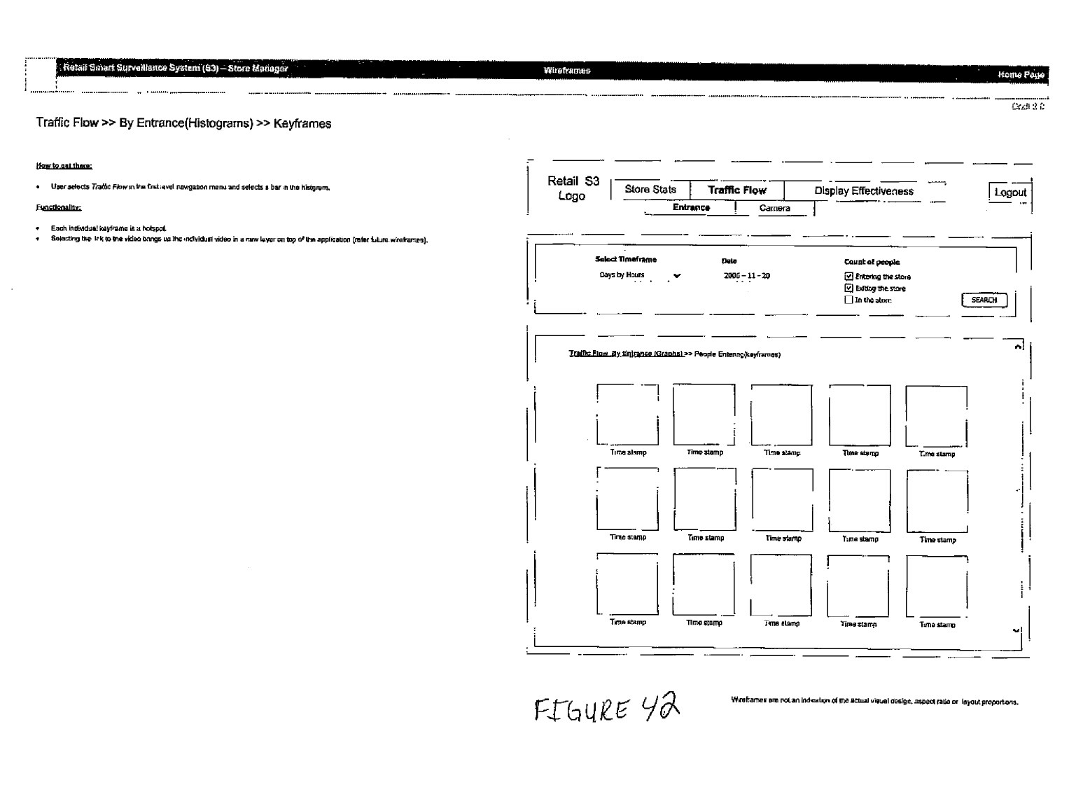

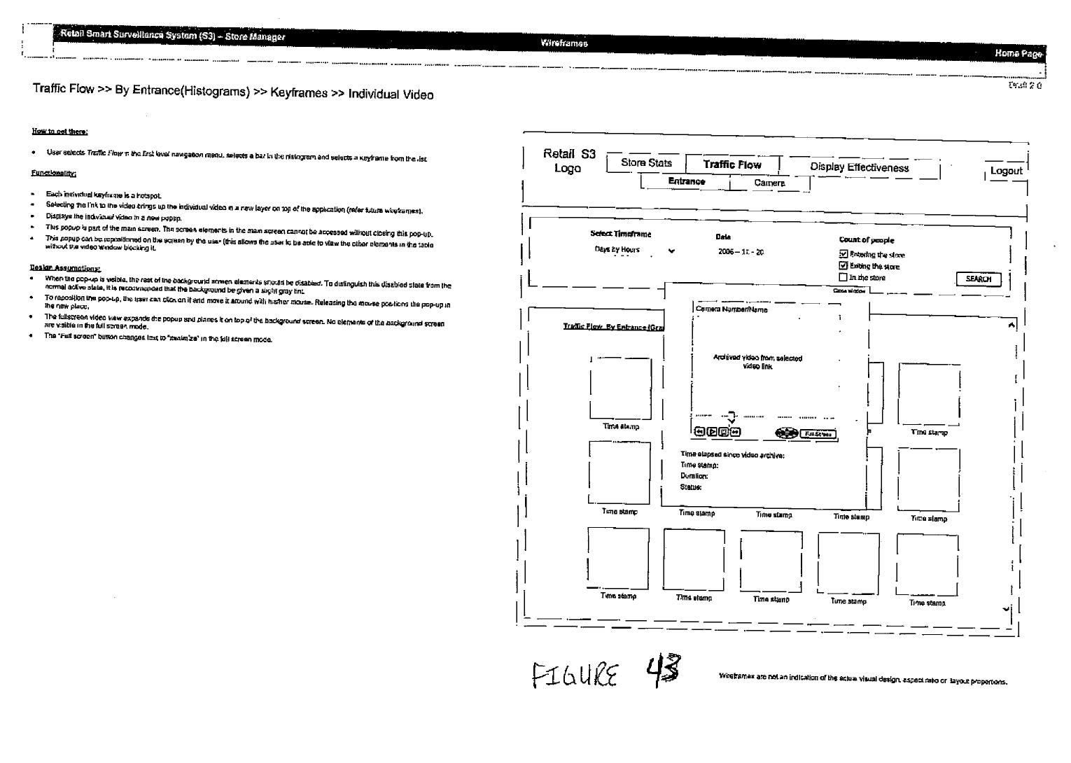

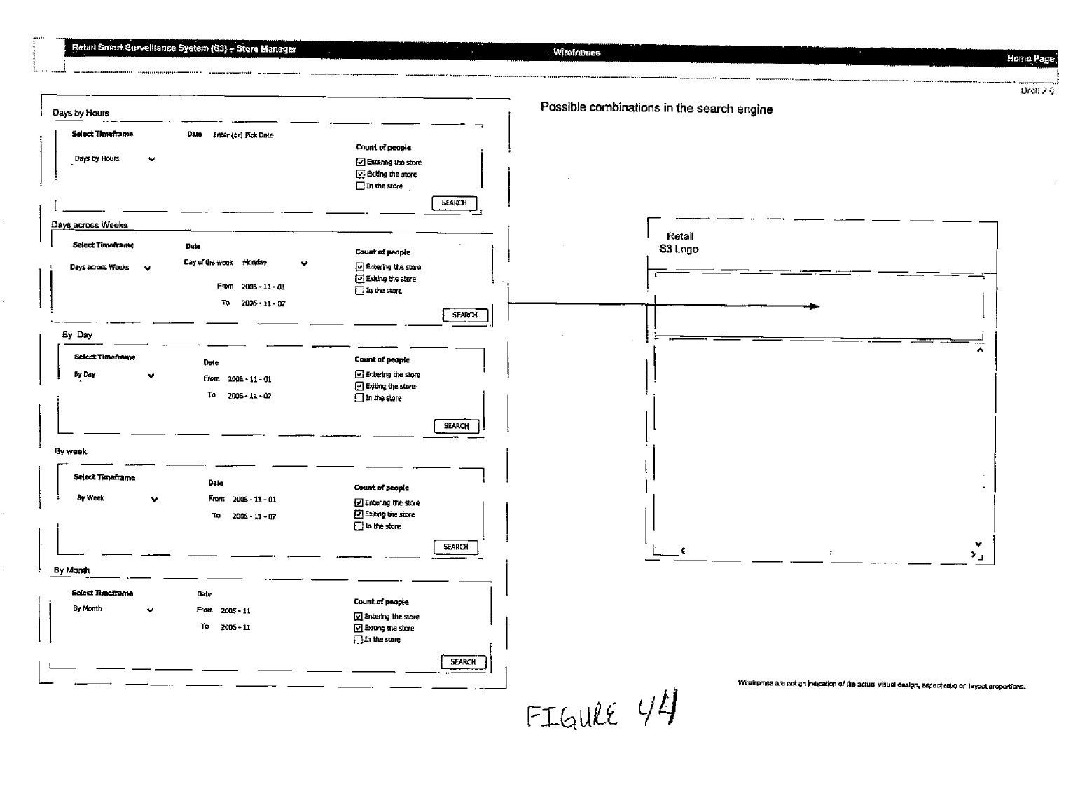

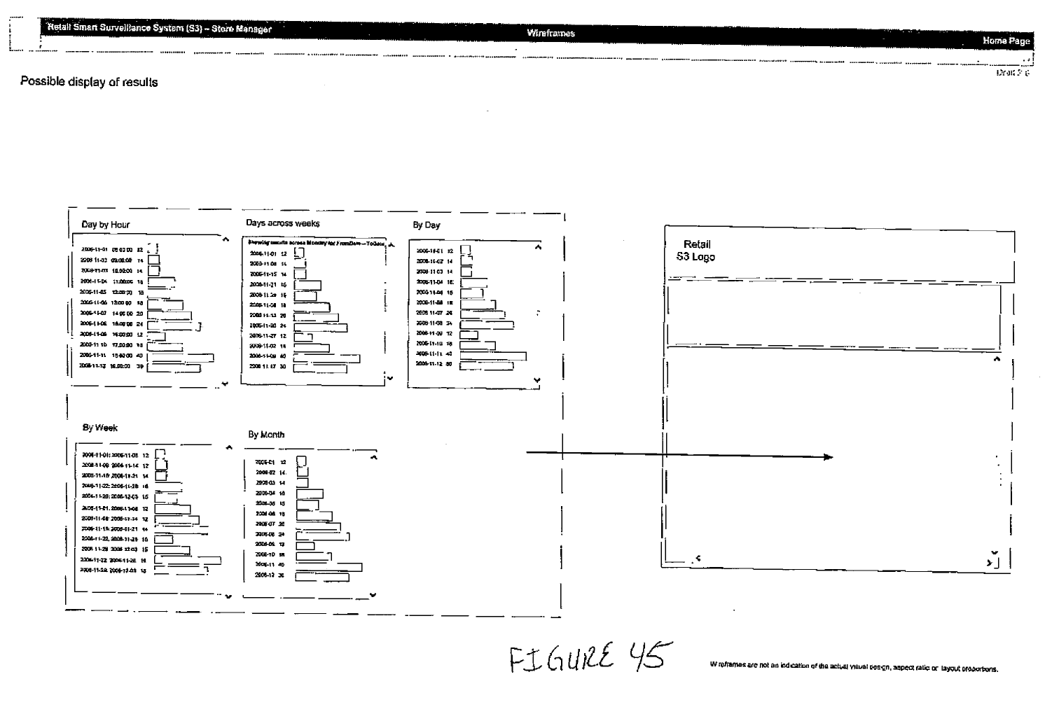

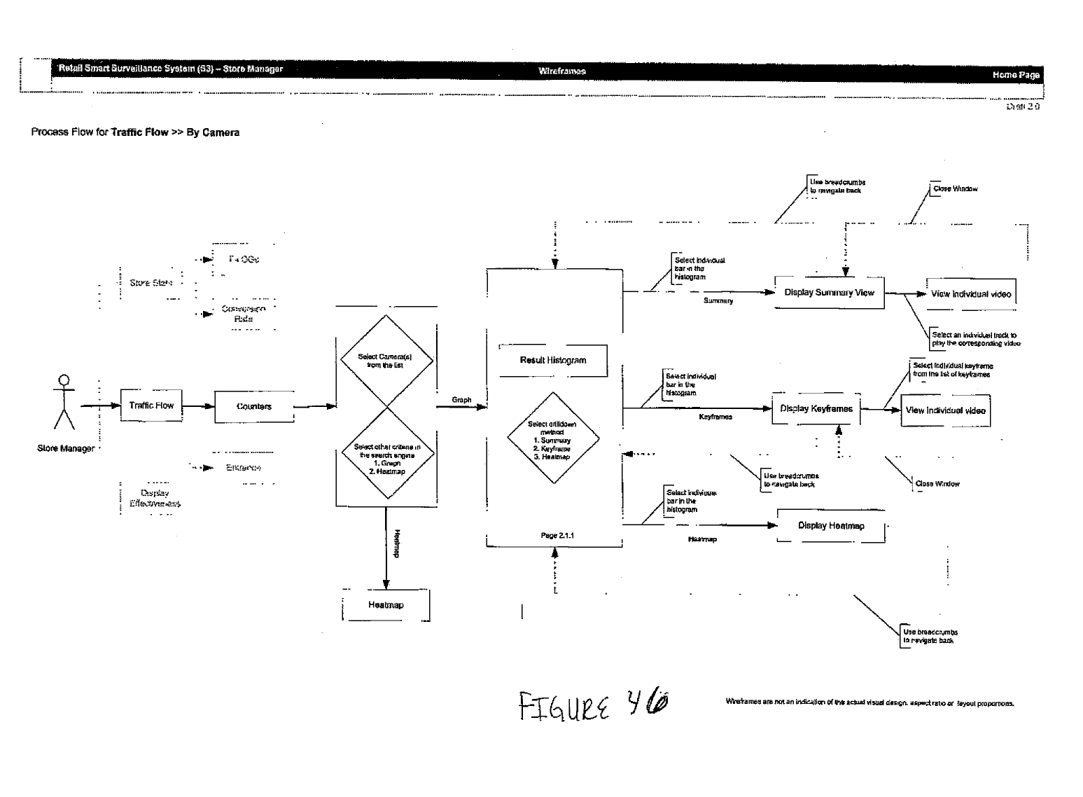

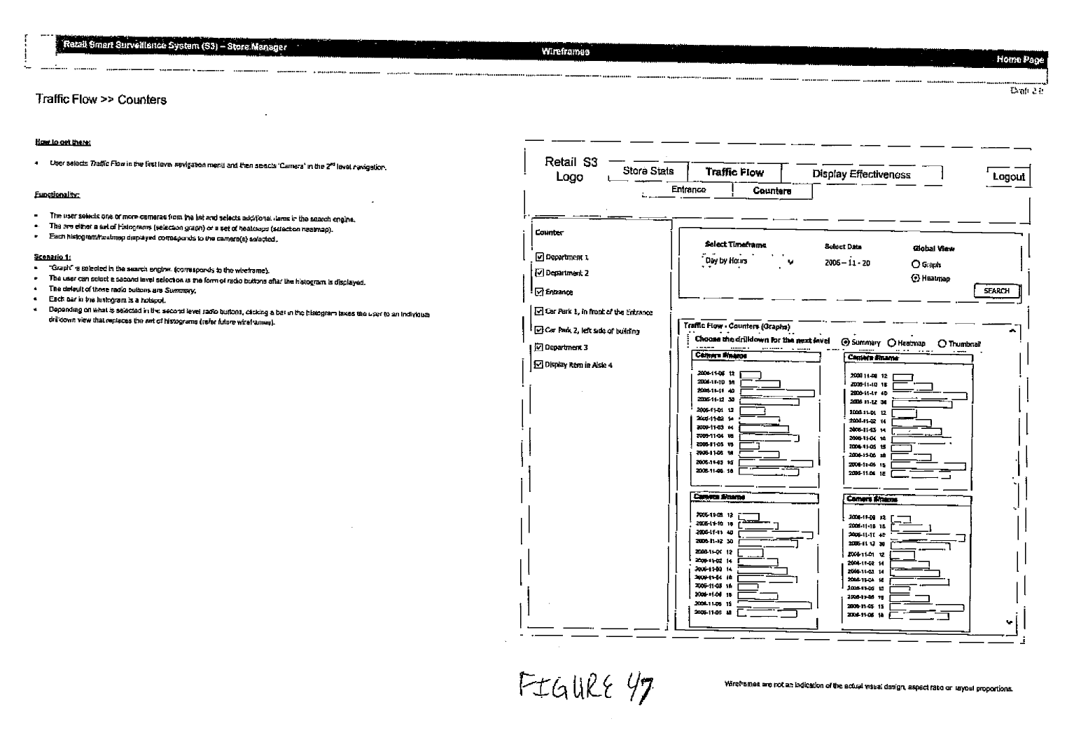

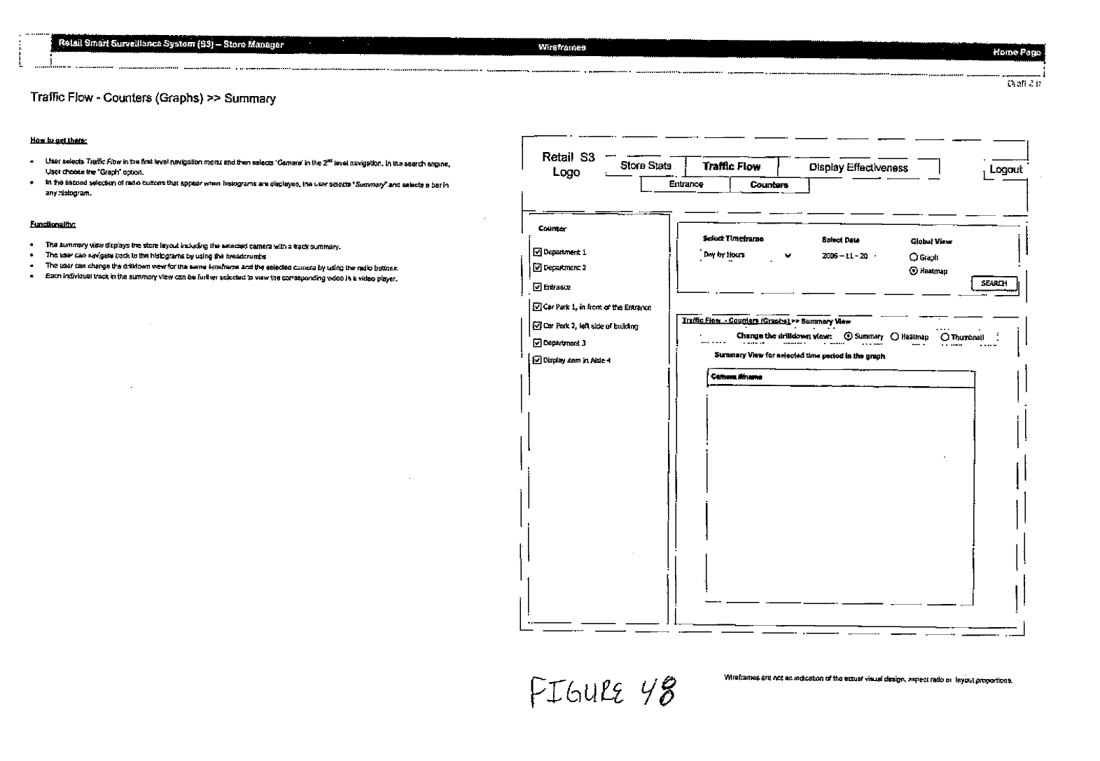

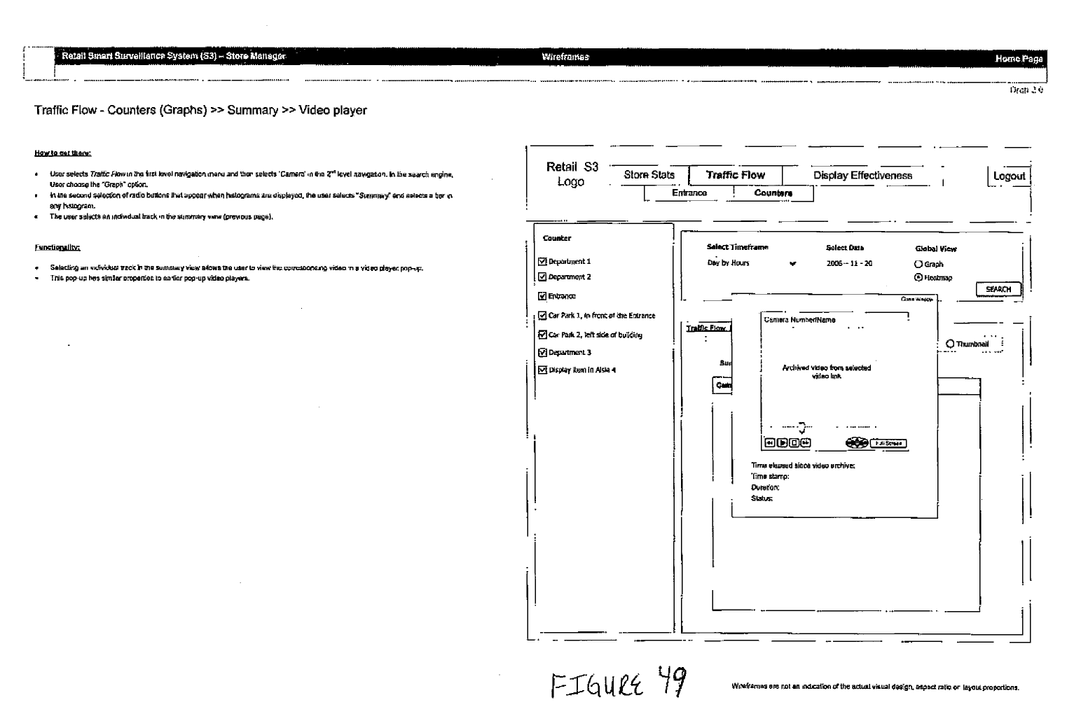

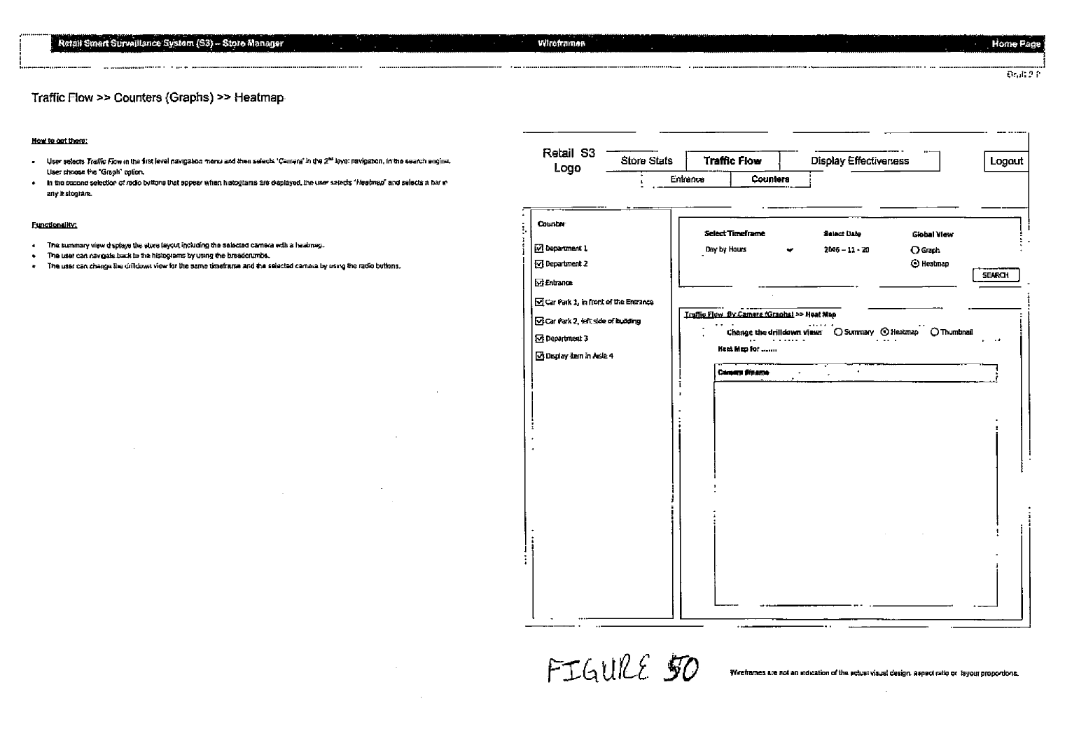

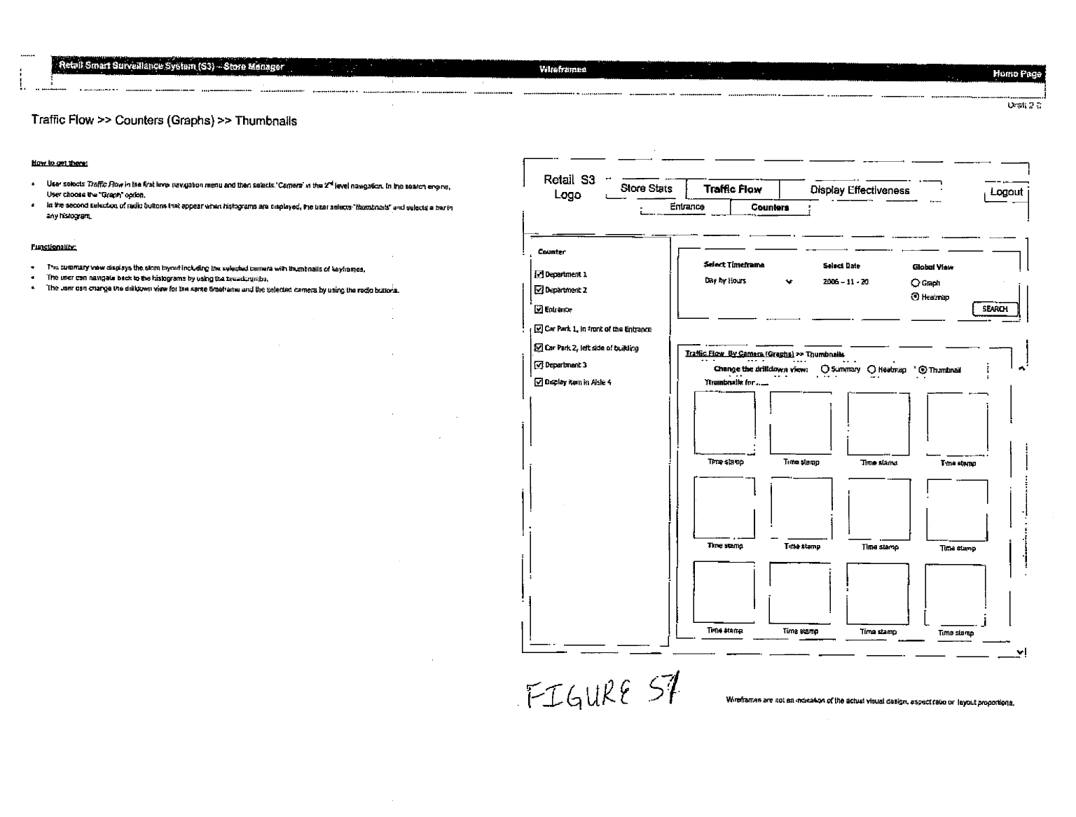

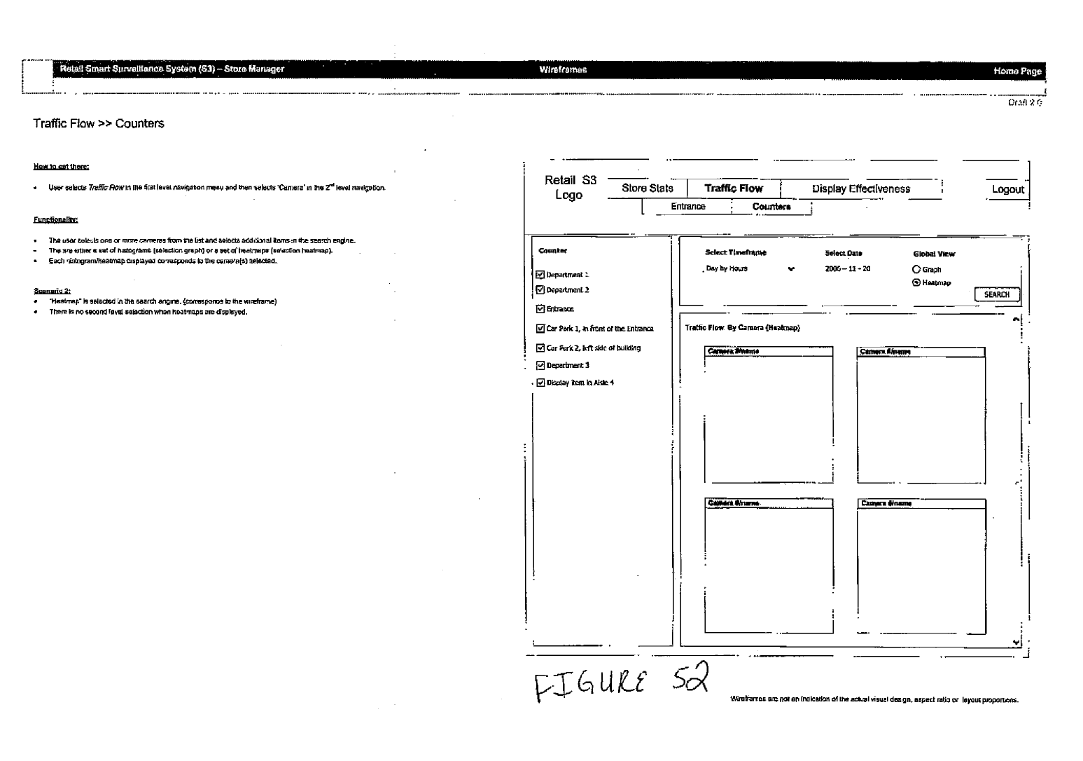

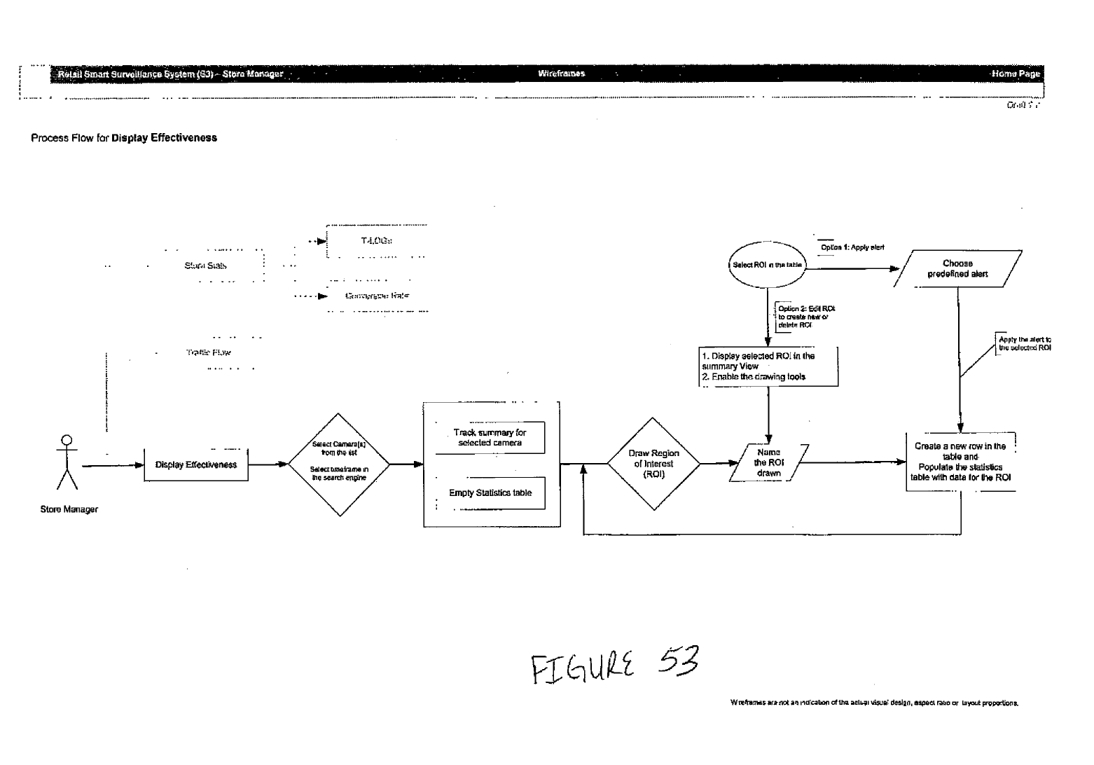

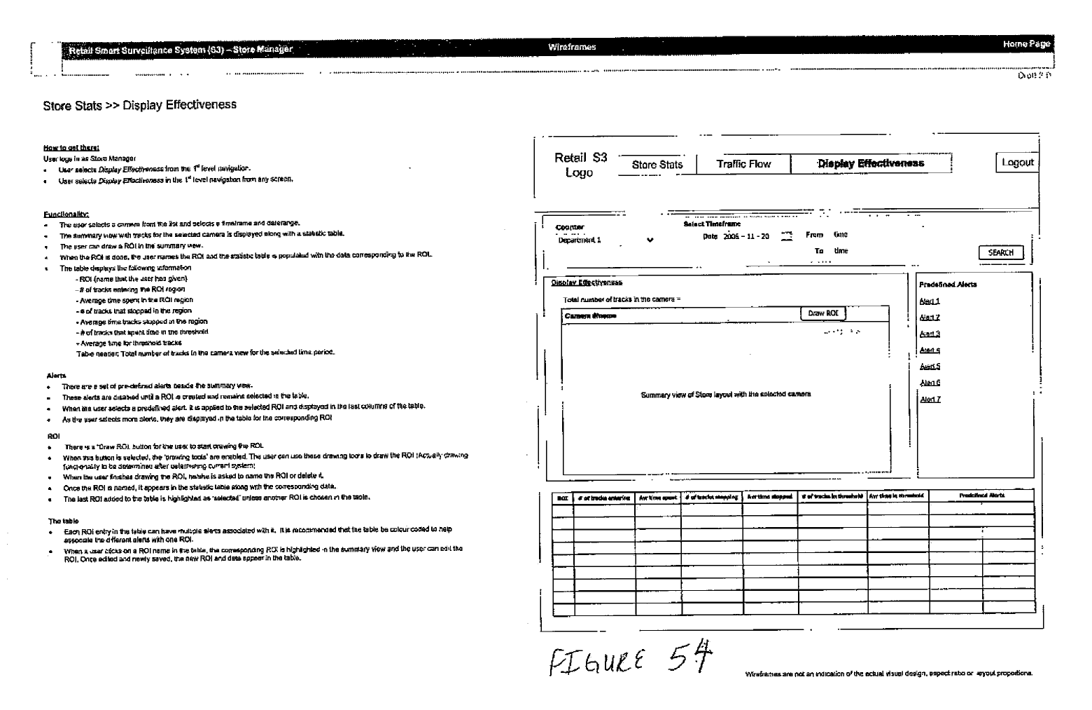

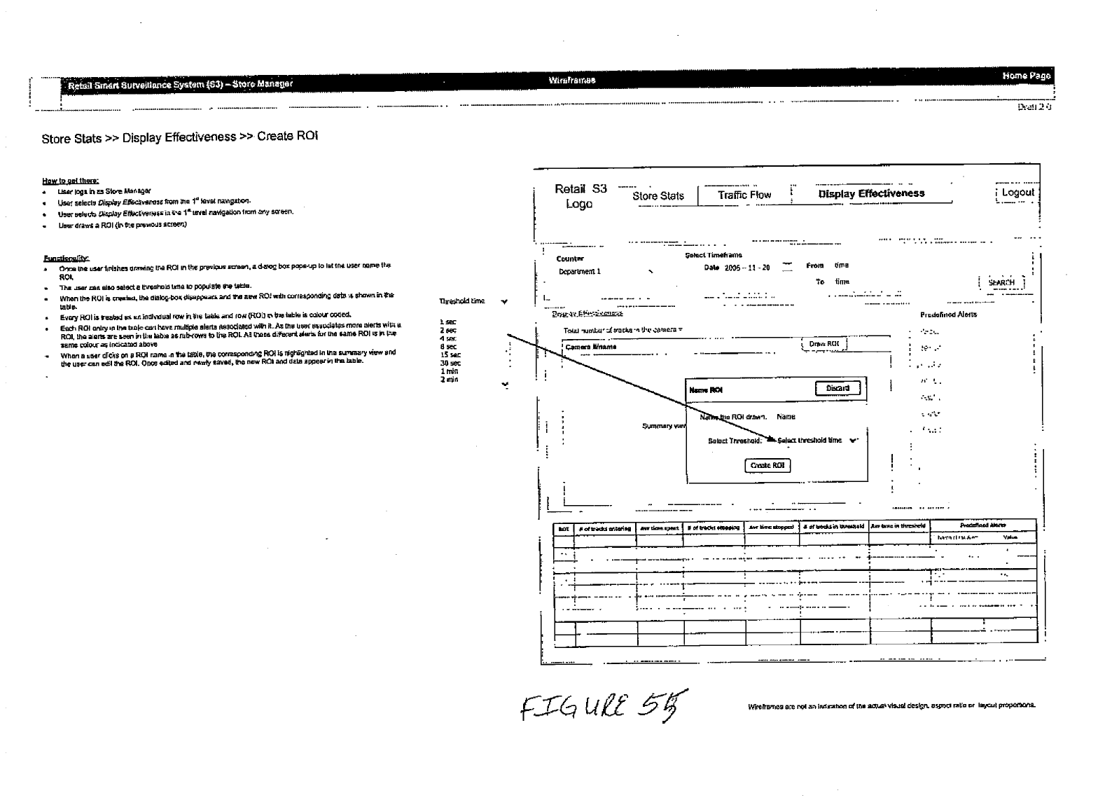

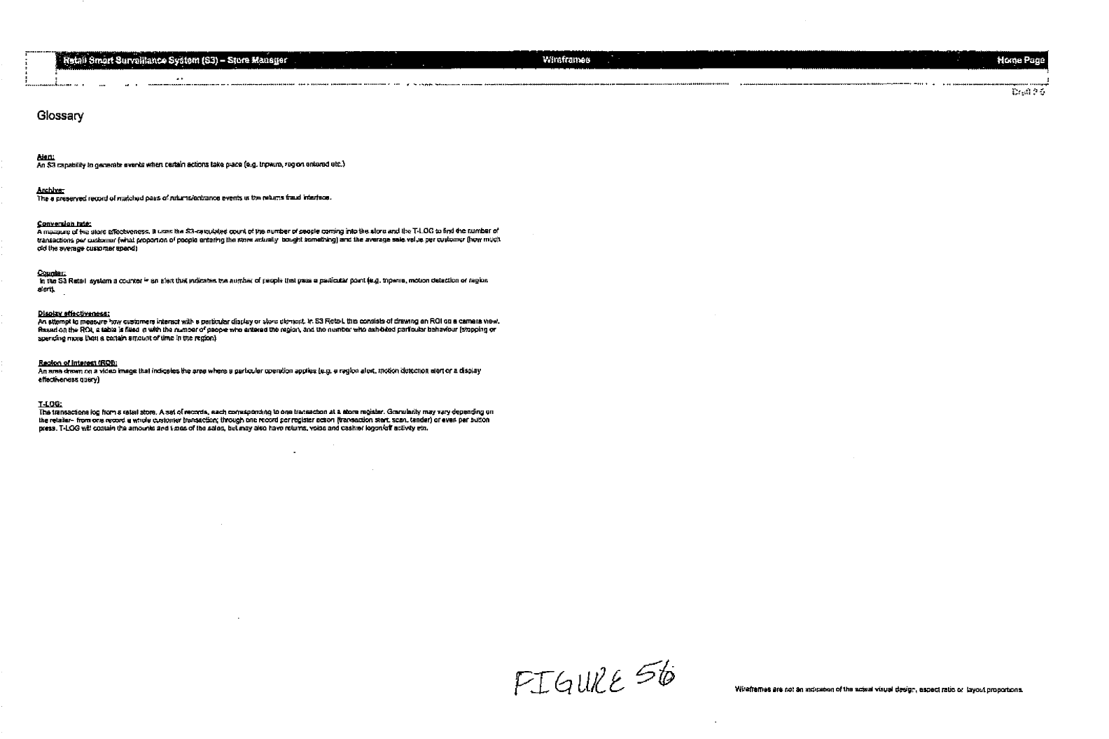

FIGS. 25-56 depict store management aspects of the present invention. Overall retail store management capabilities are significantly enhanced in several areas:

Improved Margins

Increased Accuracy

Reduced Internal Loss (˜15-35%) and Errors

Reduced Operational Expense

Improved Training, Increased Throughput

Cost Effective Deployment

Return on Investment=6 to 12 months

While shown and described herein as an event detection method, it is understood that the invention further provides various alternative embodiments. For example, in one embodiment, the invention provides a computer-readable/useable medium that includes computer program code to enable a computer infrastructure to detect events. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or a storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to detect events. In this case, the service provider can create, maintain, support, etc., a computer infrastructure that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for detecting events. In this case, a computer infrastructure can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications variations are possible. Such modifications and variations that may be apparent to a person skilled in the art are intended to be included within the scope of the invention as defined by the accompanying claims.

What is claimed is:

1. A method for detecting an event, comprising:
receiving at least one data input stream from one or more sensors;
selecting a data input stream from one of the one or more sensors;
recording the data input stream on a recordable medium;
specifying a rule comprising an event in the data input stream; and
detecting at least one event in the data input stream based upon the rule.

2. The method of claim 1, wherein the detecting is performed substantially contemporaneously with the receipt of the data input stream from the one of the one or more sensors, or based upon receipt of the data input stream from playback of the recordable medium.

3. The method of claim 2, further comprising generating an alert based upon the detecting.

4. The method of claim 3, wherein the alert comprises identifying the respective sensor that has transmitted the data input stream in which the event is detected.

5. The method of claim 4, wherein the identifying the respective sensor comprises depicting a location of the sensor on a map.

6. The method of claim 1, wherein the specifying a rule comprises marking an annotation on the data input stream.

7. The method of claim 6, wherein the annotation comprises a boundary line.

8. The method of claim 7, wherein the event comprises an object in the data input stream crossing the boundary line.

9. The method of claim 1, wherein the sensor comprises a video camera.

10. A system for detecting an event, comprising:
means for receiving at least one data input stream from one or more sensors;
means for selecting a data input stream from one of the one or more sensors;
means for recording the data input stream on a recordable medium;
means for specifying a rule comprising an event in the data input stream; and
means for detecting at least one event in the data input stream based upon the rule.

11. The system of claim 10, the means for detecting being configured to detect the at least one event substantially contemporaneously with the receipt of the data input stream from the one of the one or more sensors, or based upon receipt of the data input stream from playback of the recordable medium.

12. The system of claim 11, further comprising means for generating an alert based upon the detecting.

13. The system of claim 12, wherein the alert comprises identifying the respective sensor that has transmitted the data input stream in which the event is detected.

14. The system of claim 13, wherein the identifying the respective sensor comprises depicting a location of the sensor on a map.

15. A program product stored on a computer readable medium for detecting an event, the computer readable medium comprising program code for causing a computer system to:
receive at least one data input stream from one or more sensors;
select a data input stream from one of the one or more sensors;
record the data input stream on a recordable medium;
specify a rule comprising an event in the data input stream; and
detect at least one event in the data input stream based upon the rule.

16. The program product of claim 15, the computer readable medium further comprising program code for causing the computer system to detect the at least one event substantially contemporaneously with the receipt of the data input stream from the one of the one or more sensors, or based upon receipt of the data input stream from playback of the recordable medium.

17. The program product of claim 16, the computer readable medium further comprising program code for causing the computer system to generate an alert based upon the detecting.

18. The program product of claim 17, wherein the alert comprises identifying the respective sensor that has transmitted the data input stream in which the event is detected.

19. The program product of claim 18, the computer readable medium further comprising program code for causing the computer system to depict a location of the sensor on a map.

20. A method for deploying a system for detecting an event, comprising:
providing a computer infrastructure being operable to:
receive at least one data input stream from one or more sensors;
select a data input stream from one of the one or more sensors;
record the data input stream on a recordable medium;
specify a rule comprising an event in the data input stream; and
detect at least one event in the data input stream based upon the rule.
